(19) United States
(12) Patent Application Publication
(10) Pub. No.: US 2026/0128831 A1
(43) Pub. Date: May 7, 2026

(54) MULTI-PORT PHASE CONTINUITY REFERENCE SIGNALS

(71) Applicant: QUALCOMM Incorporated, San Diego, CA (US)

(72) Inventors: Chih-Hao LIU, San Diego, CA (US); Jing SUN, San Diego, CA (US); Jing JIANG, San Diego, CA (US)

(21) Appl. No.: 18/935,333

(22) Filed: Nov. 1, 2024

(51) Int. Cl. H04L 5/00; H04L 25/02; H04W 72/21; H04W 76/20

(52) U.S. Cl. CPC H04L 5/0051; H04L 25/0224; H04W 72/21; H04W 76/20

(57) ABSTRACT

Methods, systems, and devices for wireless communications are described. Devices may exchange multi-port phase continuity reference signals. A receiving device may determine a phase coherence between a first port and a second port. Based on the phase coherence, the receiving device may select a configuration for phase continuity reference signals including an association between one or more first ports associated with communication of demodulation reference signals (DMRSs) and one or more second ports associated with communication of the phase continuity reference signals. The receiving device may receive one or more phase continuity reference signals in accordance with the configuration, the one or more phase continuity reference signals associated with estimation of a phase discontinuity between the first port and the second port. The receiving device may perform channel estimation for the first port and the second port in accordance with the one or more phase continuity reference signals.

### FIELD OF TECHNOLOGY

The following relates to wireless communications, including multi-port phase continuity reference signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Wireless communications devices may exchange one or more reference signals. In some cases, wireless communications devices may exchange phase continuity reference signals.

### SUMMARY

The systems, methods, and devices of this disclosure each have several innovative aspects, no single one of which is solely responsible for the desirable attributes disclosed herein.

A method for wireless communications by a wireless communications device is described. The method may include determining a phase coherence between a first port and a second port, selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals, receiving one or more phase continuity reference signals in accordance with the configuration, the one or more phase continuity reference signals associated with estimation of a phase discontinuity between the first port and the second port, and performing channel estimation for the first port and the second port in accordance with the one or more phase continuity reference signals.

A wireless communications device for wireless communications is described. The wireless communications device may include one or more memories storing processor executable code, and one or more processors coupled with the one or more memories. The one or more processors may individually or collectively be operable to execute the code to cause the wireless communications device to determine a phase coherence between a first port and a second port, select a configuration for phase continuity reference signals based on the phase coherence between the first port and the second port, the configuration including an association between one or more first ports associated with communication of DMRSs and one or more second ports associated with communication of the phase continuity reference signals, receive one or more phase continuity reference signals in accordance with the configuration, the one or more phase continuity reference signals associated with estimation of a phase discontinuity between the first port and the second port, and perform channel estimation for the first port and the second port in accordance with the one or more phase continuity reference signals.

Another wireless communications device for wireless communications is described. The wireless communications device may include means for determining a phase coherence between a first port and a second port, means for selecting a configuration for phase continuity reference signals based on the phase coherence between the first port and the second port, the configuration including an association between one or more first ports associated with communication of DMRSs and one or more second ports associated with communication of the phase continuity reference signals, means for receiving one or more phase continuity reference signals in accordance with the configuration, the one or more phase continuity reference signals associated with estimation of a phase discontinuity between the first port and the second port, and means for performing channel estimation for the first port and the second port in accordance with the one or more phase continuity reference signals.

A non-transitory computer-readable medium storing code for wireless communications is described. The code may include instructions executable by one or more processors to determine a phase coherence between a first port and a second port, select a configuration for phase continuity reference signals based on the phase coherence between the first port and the second port, the configuration including an association between one or more first ports associated with communication of DMRSs and one or more second ports associated with communication of the phase continuity reference signals, receive one or more phase continuity reference signals in accordance with the configuration, the one or more phase continuity reference signals associated with estimation of a phase discontinuity between the first port and the second port, and perform channel estimation for the first port and the second port in accordance with the one or more phase continuity reference signals.

Some examples of the method, wireless communications devices, and non-transitory computer-readable medium described herein may further include operations, features, means, or instructions for receiving one or more radio resource control (RRC) messages indicating the phase coherence, where determining the phase coherence between the first port and the second port may be based on the one or more RRC messages.

In some examples of the method, wireless communications devices, and non-transitory computer-readable medium described herein, the one or more RRC messages include a capability report, an indication of one or more coherent ports, or both.

In some examples of the method, wireless communications devices, and non-transitory computer-readable medium described herein, the one or more phase continuity reference signals may be received via the one or more second ports including the second port in accordance with the configuration, the one or more second ports associated with the one or more first ports that include one or more active DMRS ports.

Some examples of the method, wireless communications devices, and non-transitory computer-readable medium described herein may further include operations, features, means, or instructions for identifying one or more phase coherence groups based on the phase coherence between the first port and the second port, where: each phase coherence group of the one or more phase coherence groups includes a first set of multiple ports associated with the communication of the DMRSs, and the first set of multiple ports correspond to a second set of multiple ports associated with the communication of the phase continuity reference signals and selecting, for each phase coherence group of the one or more phase coherence groups, a respective port of the second set of multiple ports having a lowest port index.

Some examples of the method, wireless communications devices, and non-transitory computer-readable medium described herein may further include operations, features, means, or instructions for identifying one or more phase coherence groups based on the phase coherence between the first port and the second port, where: each phase coherence group of the one or more phase coherence groups includes one or more code division multiplexing (CDM) groups, each CDM group of the one or more CDM groups includes a first set of multiple ports associated with the communication of the DMRSs, and the first set of multiple ports correspond to a second set of multiple ports associated with the communication of the phase continuity reference signals and selecting, for each CDM group of the one or more CDM groups of each phase coherence group, a respective port of the second set of multiple ports having a lowest port index of the second set of multiple ports.

In some examples of the method, wireless communications devices, and non-transitory computer-readable medium described herein, based on one or more ports associated with the communication of the DMRSs in a code division multiplexing (CDM) group being non-coherent or partial coherent, the configuration may include operations, features, means, or instructions for receiving a first phase continuity reference signal via a first resource element associated with the third port and receiving a second phase continuity reference signal via a second resource element associated with the fourth port.

In some examples of the method, wireless communications devices, and non-transitory computer-readable medium described herein, the one or more ports associated with the communication of the DMRSs include active DMRS ports.

In some examples of the method, wireless communications devices, and non-transitory computer-readable medium described herein, based on one or more ports associated with the communication of the DMRSs in a CDM group being coherent, the configuration may include operations, features, means, or instructions for receiving a first phase continuity reference signal via a first resource element associated with the third port and the fourth port or associated with the third port.

In some examples of the method, wireless communications devices, and non-transitory computer-readable medium described herein, the one or more ports associated with the communication of the DMRSs include active DMRS ports.

In some examples of the method, wireless communications devices, and non-transitory computer-readable medium described herein, the configuration for the phase continuity reference signals may be associated with a CDM group.

Some examples of the method, wireless communications devices, and non-transitory computer-readable medium described herein may further include operations, features, means, or instructions for communicating a control message indicative of the configuration for the phase continuity reference signals based on the phase coherence between the first port and the second port, where receiving the one or more phase continuity reference signals may be based on the control message.

In some examples of the method, wireless communications devices, and non-transitory computer-readable medium described herein, the control message includes a mapping of the one or more first ports associated with the communication of the DMRSs to the one or more second ports associated with the communication of the phase continuity reference signals and the one or more first ports include active DMRS ports.

Some examples of the method, wireless communications devices, and non-transitory computer-readable medium described herein may further include operations, features, means, or instructions for receiving an uplink control information (UCI) message indicative of a capability of a user equipment (UE) to adjust the phase coherence.

A method for wireless communications by a wireless communications device is described. The method may include determining a phase coherence between a first port and a second port, selecting a configuration for phase continuity reference signals based on the phase coherence between the first port and the second port, the configuration including an association between one or more first ports associated with communication of DMRSs and one or more second ports associated with communication of the phase continuity reference signals, and transmitting one or more phase continuity reference signals in accordance with the configuration, the one or more phase continuity reference signals associated with estimation of a phase discontinuity between the first port and the second port.

A wireless communications device for wireless communications is described. The wireless communications device may include one or more memories storing processor executable code, and one or more processors coupled with the one or more memories. The one or more processors may individually or collectively be operable to execute the code to cause the wireless communications device to determine a phase coherence between a first port and a second port, select a configuration for phase continuity reference signals based on the phase coherence between the first port and the second port, the configuration including an association between one or more first ports associated with communication of DMRSs and one or more second ports associated with communication of the phase continuity reference signals, and transmit one or more phase continuity reference signals in accordance with the configuration, the one or more phase continuity reference signals associated with estimation of a phase discontinuity between the first port and the second port.

Another wireless communications device for wireless communications is described. The wireless communications device may include means for determining a phase coherence between a first port and a second port, means for selecting a configuration for phase continuity reference signals based on the phase coherence between the first port and the second port, the configuration including an association between one or more first ports associated with communication of DMRSs and one or more second ports associated with communication of the phase continuity reference signals, and means for transmitting one or more phase continuity reference signals in accordance with the configuration, the one or more phase continuity reference signals associated with estimation of a phase discontinuity between the first port and the second port.

A non-transitory computer-readable medium storing code for wireless communications is described. The code may include instructions executable by one or more processors to determine a phase coherence between a first port and a second port, select a configuration for phase continuity reference signals based on the phase coherence between the first port and the second port, the configuration including an association between one or more first ports associated with communication of DMRSs and one or more second ports associated with communication of the phase continuity reference signals, and transmit one or more phase continuity reference signals in accordance with the configuration, the one or more phase continuity reference signals associated with estimation of a phase discontinuity between the first port and the second port.

Some examples of the method, wireless communications devices, and non-transitory computer-readable medium described herein may further include operations, features, means, or instructions for communicating one or more RRC messages indicating the phase coherence, where determining the phase coherence between the first port and the second port may be based on the one or more RRC messages.

In some examples of the method, wireless communications devices, and non-transitory computer-readable medium described herein, the one or more RRC messages include a capability report, an indication of one or more coherent ports, or both.

In some examples of the method, wireless communications devices, and non-transitory computer-readable medium described herein, the one or more phase continuity reference signals may be transmitted via the one or more second ports including the first port in accordance with the configuration, the one or more second ports associated with the one or more first ports that include one or more active DMRS ports.

Some examples of the method, wireless communications devices, and non-transitory computer-readable medium described herein may further include operations, features, means, or instructions for identifying one or more phase coherence groups based on the phase coherence between the first port and the second port, where: each phase coherence group of the one or more phase coherence groups includes a first set of multiple ports associated with the communication of the DMRSs, and the first set of multiple ports correspond to a second set of multiple ports associated with the communication of the phase continuity reference signals and selecting, for each phase coherence group of the one or more phase coherence groups, a respective port of the second set of multiple ports having a lowest port index.

Some examples of the method, wireless communications devices, and non-transitory computer-readable medium described herein may further include operations, features, means, or instructions for identifying one or more phase coherence groups based on the phase coherence between the first port and the second port, where: each phase coherence group of the one or more phase coherence groups includes one or more CDM groups, each CDM group of the one or more CDM groups includes a first set of multiple ports associated with the communication of the DMRSs, and the first set of multiple ports correspond to a second set of multiple ports associated with the communication of the phase continuity reference signals and selecting, for each CDM group of the one or more CDM groups of each phase coherence group, a respective port of the second set of multiple ports having a lowest port index of the second set of multiple ports.

In some examples of the method, wireless communications devices, and non-transitory computer-readable medium described herein, based on one or more ports associated with the communication of the DMRSs in a CDM group being non-coherent or partial coherent, the configuration may include operations, features, means, or instructions for transmitting a first phase continuity reference signal via a first resource element associated with the third port and transmitting a second phase continuity reference signal via a second resource element associated with the fourth port.

In some examples of the method, wireless communications devices, and non-transitory computer-readable medium described herein, the one or more ports associated with the communication of the DMRSs include active DMRS ports.

In some examples of the method, wireless communications devices, and non-transitory computer-readable medium described herein, based on one or more ports associated with the communication of the DMRSs in a CDM group being coherent, the configuration may include operations, features, means, or instructions for transmitting a first phase continuity reference signal via a first resource element associated with the third port and the fourth port or associated with the third port.

In some examples of the method, wireless communications devices, and non-transitory computer-readable medium described herein, the one or more ports associated with the communication of the DMRSs include active DMRS ports.

In some examples of the method, wireless communications devices, and non-transitory computer-readable medium described herein, the configuration for the phase continuity reference signals may be associated with a CDM group.

Some examples of the method, wireless communications devices, and non-transitory computer-readable medium described herein may further include operations, features, means, or instructions for communicating a control message indicative of the configuration for the phase continuity reference signals based on the phase coherence between the first port and the second port, where transmitting the one or more phase continuity reference signals may be based on the control message.

In some examples of the method, wireless communications devices, and non-transitory computer-readable medium described herein, the control message includes a mapping of the one or more first ports associated with the communication of the DMRSs to the one or more second ports associated with the communication of the phase continuity reference signals and the one or more first ports include active DMRS ports.

Some examples of the method, wireless communications devices, and non-transitory computer-readable medium described herein may further include operations, features, means, or instructions for transmitting an UCI message indicative of a capability of a UE to adjust the phase coherence.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support multi-port phase continuity reference signals in accordance with one or more aspects of the present disclosure.

FIGS. 3A and 3B show examples of resource diagrams that support multi-port phase continuity reference signals in accordance with one or more aspects of the present disclosure.

FIG. 4 shows an example of a process flow that supports multi-port phase continuity reference signals in accordance with one or more aspects of the present disclosure.

FIGS. 5 and 6 show block diagrams of devices that support multi-port phase continuity reference signals in accordance with one or more aspects of the present disclosure.

FIG. 7 shows a block diagram of a communications manager that supports multi-port phase continuity reference signals in accordance with one or more aspects of the present disclosure.

FIG. 8 shows a diagram of a system including a device that supports multi-port phase continuity reference signals in accordance with one or more aspects of the present disclosure.

FIGS. 9 and 10 show block diagrams of devices that support multi-port phase continuity reference signals in accordance with one or more aspects of the present disclosure.

FIG. 11 shows a block diagram of a communications manager that supports multi-port phase continuity reference signals in accordance with one or more aspects of the present disclosure.

FIG. 12 shows a diagram of a system including a device that supports multi-port phase continuity reference signals in accordance with one or more aspects of the present disclosure.

FIGS. 13 through 16 show flowcharts illustrating methods that support multi-port phase continuity reference signals in accordance with one or more aspects of the present disclosure.

### DETAILED DESCRIPTION

Some wireless devices operating in a wireless communications system may experience phase discontinuity during communications. That is, a phase jump boundary (e.g., a logical or physical gap where phase continuity is not maintained) may be present within time resources (e.g., slots) allocated for communications between a receiving wireless device and a transmitting wireless device, where the phase jump boundary may be present due to radio frequency reconfigurations at either the receiving or transmitting wireless device, be present at a boundary between two slots, among other cases. Such phase jump boundaries may reduce the phase continuity during communications, leading to inaccurate channel estimations at the receiving wireless device, thereby degrading communications. To remedy such phase discontinuities, the transmitting wireless device may transmit a phase continuity reference signal around (e.g., before or after) the phase jump boundaries, such that the receiving wireless device may estimate the phase jump (e.g., estimate the change in phase at the phase jump boundary) across the phase jump boundaries and perform channel estimations.

In addition to phase discontinuity associated with a phase jump boundary, phase discontinuity may exist between different ports, including ports associated with or used for communication of demodulation reference signals (DMRSs). For example, DMRS ports may have phase coherence or non-coherence. Accordingly, wireless devices may transmit phase continuity reference signals via ports that correspond to or are associated with the DMRS ports to measure phase discontinuity. However, in some cases, coherent DMRS ports may share a same phase continuity reference signal port to reduce complexity and overhead. Accordingly, techniques described herein support phase continuity reference signal port sharing and DMRS port-to-phase continuity reference signal port association.

As described herein, wireless devices may exchange phase continuity reference signals according to a configuration that associates DMRS ports with phase continuity reference signal ports in accordance with a phase coherence between DMRS ports. For example, a receiving device may determine a phase coherence between a first port and a second port. Based on the phase coherence, the receiving device may select a configuration for phase continuity reference signals including an association between one or more first ports associated with communication of DMRSs and one or more second ports associated with communication of the phase continuity reference signals. The receiving device may receive one or more phase continuity reference signals in accordance with the configuration, the one or more phase continuity reference signals associated with estimation of a phase discontinuity between the first port and the second port. The receiving device may perform channel estimation for the first port and the second port in accordance with the one or more phase continuity reference signals.

Aspects of the disclosure are initially described in the context of wireless communications systems. Aspects of the disclosure are also described in the context of resource diagrams and process flows. Aspects of the disclosure are further illustrated by and described with reference to apparatus diagrams, system diagrams, and flowcharts that relate to multi-port phase continuity reference signals.

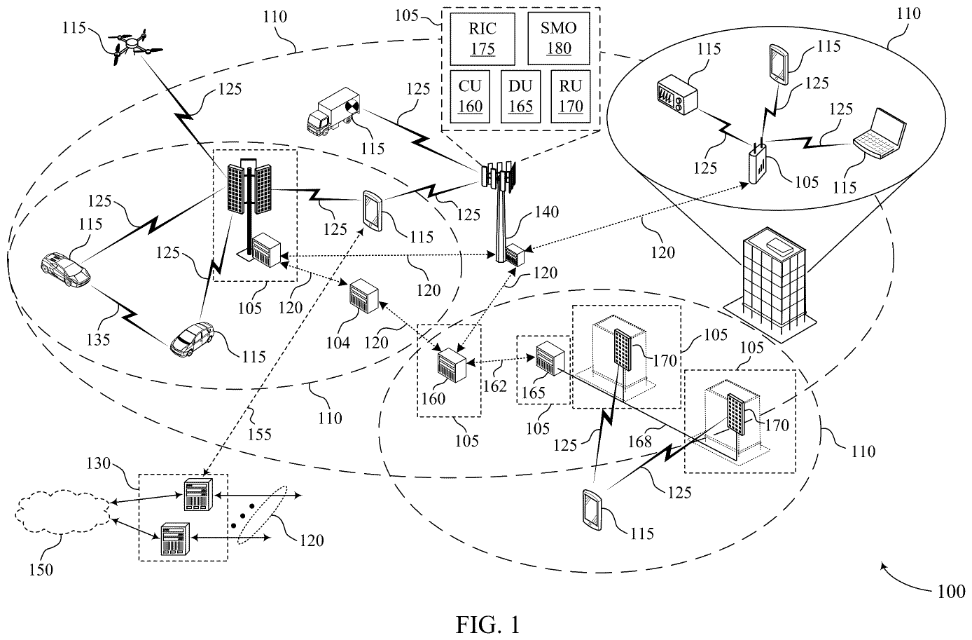

FIG. 1 shows an example of a wireless communications system 100 that supports multi-port phase continuity reference signals in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support multi-port phase continuity reference signals as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless devices (e.g., UEs 115 and network entities 105) operating in a wireless communications system may experience phase discontinuity during communications. That is, a phase jump boundary (e.g., a logical or physical gap where phase continuity is not maintained) may be present within time resources (e.g., slots) allocated for communications between a receiving wireless device and a transmitting wireless device, where the phase jump boundary may be present due to radio frequency reconfigurations at either the receiving or transmitting wireless device, be present at a boundary between two slots, among other cases. Such phase jump boundaries may reduce the phase continuity during communications, leading to inaccurate channel estimations at the receiving wireless device, thereby degrading communications. To remedy such phase discontinuities, the transmitting wireless device may transmit a phase continuity reference signal around (e.g., before or after) the phase jump boundaries, such that the receiving wireless device may estimate the phase jump (e.g., estimate the change in phase at the phase jump boundary) and perform channel estimations.

In addition to phase discontinuity associated with a phase jump boundary, phase discontinuity may exist between different ports, including ports associated with or used for communication of demodulation reference signals (DMRSs). For example, DMRS ports may have phase coherence or non-coherence. Accordingly, wireless devices (e.g., UEs 115 and network entities 105) may transmit phase continuity reference signals via ports that correspond to or are associated with the DMRS ports to measure phase discontinuity. However, in some cases, coherent DMRS ports may share a same phase continuity reference signal port to reduce complexity and overhead. Accordingly, techniques described herein support phase continuity reference signal port sharing and DMRS port-to-phase continuity reference signal port association.

As described herein, wireless devices (e.g., UEs 115 and network entities 105) may exchange phase continuity reference signals according to a configuration that associates DMRS ports with phase continuity reference signal ports in accordance with a phase coherence between DMRS ports. For example, a receiving device (e.g., a UE 115 or network entity 105) may determine a phase coherence between a first port and a second port. Based on the phase coherence, the receiving device may select a configuration for phase continuity reference signals including an association between one or more first ports associated with communication of DMRSs and one or more second ports associated with communication of the phase continuity reference signals. The receiving device may receive one or more phase continuity reference signals in accordance with the configuration, the one or more phase continuity reference signals associated with estimation of a phase discontinuity between the first port and the second port. The receiving device may perform channel estimation for the first port and the second port in accordance with the one or more phase continuity reference signals.

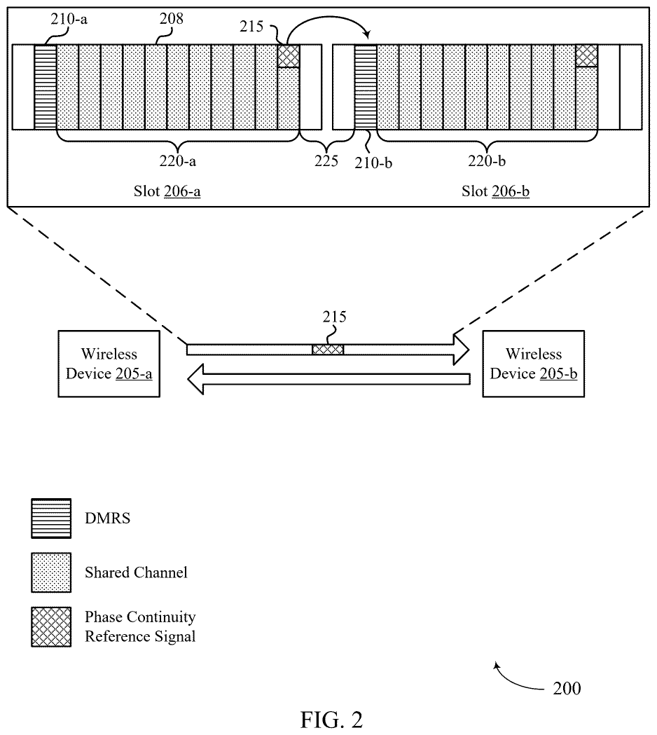

FIG. 2 shows an example of a wireless communications system 200 that supports multi-port phase continuity reference signals in accordance with one or more aspects of the present disclosure. Aspects of the wireless communications system 200 may implement, or be implemented by, aspects of the wireless communications system 100, as described herein with reference to FIG. 1. In some aspects, the wireless device 205-a may be a UE 115 or a network entity 105, while the wireless device 205-b may be a UE 115 or a network entity 105.

In some cases, the wireless devices 205 may communicate data via shared channels 220 (e.g., physical uplink shared channels (PUSCHs), physical downlink shared channels (PDSCHs), physical sidelink shared channels (PSSCHs)), where the shared channel 220 may occupy (e.g., be transmitted via) one or more symbols 208 within a slot 206. In such cases, for repeated shared channel transmissions (e.g., PUSCH transmissions), multiple segments of back-to-back symbols 208 may be utilized to extend coverage (e.g., PUSCH coverage), where such repetitions of the shared channel 220 may have different redundancy values and each repetition of the shared channel 220 may not cross boundaries between slots 206.

In some cases, the wireless devices 205 may support a fluid start length indicator value (SLIV) (e.g., a long SLIV) design, which may enable the wireless devices to communicate the shared channel 220 across slot boundaries. That is, in some wireless systems, the wireless devices 205 may allocate, via a SLIV, up to 14 symbols 208 of a slot 206 for the communication of a shared channel 220. In the fluid SLIV design, however, the wireless devices 205 may support a slot 206 with greater than 14 symbols 208, where such fluid SLIVs may avoid complicated designs to extend coverage and include demodulation reference signal (DMRS) overhead reduction by applying a more uniform time domain DMRS pattern based on the Doppler affect experienced by the wireless devices, among other factors. In this way, using the fluid SLIV design, the wireless devices 205 may communicate an increased quantity of data (or repetitions) of the shared channel 220 via a single slot 206.

As described herein, to support the fluid SLIV design and reduce time domain density of DMRSs 210, the wireless devices 205 may utilize a group of DMRS symbols within a time span (e.g., a channel estimation window) to interpolate the channel, where the size of the channel estimating window for DMRS bundling may be based on a buffer constraint at the wireless devices 205 (e.g., the UE or receiving device). In such cases, the wireless devices 205 may allocate the symbols 208 for the DMRSs 210 such that the DMRSs 210 are uniformly distributed over a duration, thereby minimizing overhead.

Such uniform distribution of DMRSs may also be utilized across different slots 206 (e.g., different SLIVs) to support extended coverage of shared channels 220. By utilizing multiple slots 206 (e.g., SLIVs) for the communication of the shared channel 220, the wireless devices 205 may schedule resources dynamically (e.g., in real time or on the fly), while the fluid SLIV design may lead to a pre-committed schedule. That is, the wireless device 205-a (e.g., a transmitting device, network entity 105, UE 115) may schedule the wireless device 205-b (e.g., receiving device or UE 115) with back-to-back slots 206, such as the slot 206-a and the slot 206-b, and indicate the use of the same precoder for transmission of the shared channels 220-a and 220-b in the case of bursty traffic. In such cases, the wireless device 205-a may not change precoders between the transmission of the shared channel 220-a and the transmission of the shared channel 220-b based on the low duty cycle sounding reference signal (SRS) transmissions or channel state information (CSI) reports.

As such, if the wireless device 205-a allocates back-to-back slots 206 for transmission of shared channels 220-a and 220-b to the wireless device 205-b, the wireless device 205-b may exploit the DMRSs 210 in adjacent slots 206 (e.g., SLIVs) jointly to further improve DMRS overhead and performance. That is, the wireless devices 205 may support DMRS sharing across multiple slots 206 (e.g., SLIVs). In such cases, such as for downlink shared channels 220 (e.g., PDSCHs), the wireless device 205-a may allocate, via control information, a DMRS 210-a in the slot 206-a and also allocate a DMRS 210-b for the slot 206-b and may instruct the wireless device 205-b to perform cross-slot combining of the DMRSs 210 (e.g., utilize the measurements from the DMRS 210-a and DMRS 210-b to receive and decode the shared channels 220), such that DMRS overhead may be reduced. In this way, the wireless device 205-b may perform DMRS sharing across the slot 206-a and the slot 206-b. Such operations may be utilized for both intra-UE sharing and inter-UE sharing.

In both DMRS sharing and fluid SLIV allocations, however, the wireless devices 205 may experience phase discontinuity, which may lead to inaccurate channel estimations at the wireless device 205-b, thereby degrading communications. In the case of DMRS sharing across multiple slots 206, the wireless devices 205 may experience a phase jump boundary 225 at a boundary between the slot 206-a and the slot 206-b, which may lead to phase discontinuity in the communication of the shared channels 220. Similarly, in fluid SLIV designs (e.g., a single slot 206 with greater than 14 symbols), the wireless devices 205 may experience one or more phase jump boundaries 225 between one or more symbols 208 of the slot 206 due to radio frequency reconfigurations at modems of the wireless devices 205, among other factors.

As such, to enable the wireless device 205-b (e.g., receiving device) to estimate phase jumps and perform accurate channel estimations around phase jump boundaries 225, the wireless device 205-a may transmit one or more phase continuity reference signals 215 (e.g., glue reference signals) around the potential phase jump boundaries 225. As described herein, a phase jump boundary may be a logical (e.g., phase change due to reconfigurations or factors occurring at the wireless devices) or a physical gap (e.g., a boundary of slot between time or frequency resources) in which a phase jump (e.g., change in phase), a phase gain, or a phase state change may occur.

As an illustrative aspect, the wireless device 205-a may transmit, in a symbol 208 prior to the phase jump boundary 225 between the slot 206-a and the slot 206-b, a phase continuity reference signal 215, such that the wireless device 205-b may perform a first phase estimation using the phase continuity reference signal 215. The wireless device 205-b may receive the DMRS 210-b and perform a second phase estimation using the DMRS 210-b. Using both the first and second phase estimations, the wireless device 205-b may estimate the phase jump (e.g., change in phase or phase gain) across the phase jump boundary 225 and perform the joint channel estimations. In this way, the wireless device 205-b may accurately perform the joint channel estimations using both phase estimations, which may improve communications between the wireless device 205-a and the wireless device 205-b.

In addition to or alternatively from phase discontinuity associated with the phase jump boundary 225 (e.g., a logical or physical gap where phase continuity is not maintained), phase discontinuity may exist between different ports, including ports associated with or used for communication of DMRSs 210 (e.g., DMRS ports). For example, the wireless devices 205 may each include multiple DMRS ports by which DMRSs are communicated (e.g., transmitted, received, or both). The multiple DMRS ports may be coherent or non-coherent. other words, one or more first DMRS ports may have phase coherence (e.g., have phase continuity) or not have phase coherence (e.g., have phase discontinuity) with one or more second DMRS ports. As such, to enable the wireless device 205-b (e.g., receiving device) to estimate phase jumps and perform accurate channel estimations using the DMRS ports, the wireless device 205-a may transmit one or more phase continuity reference signals 215 (e.g., glue reference signals) to enable measurement of and compensation for phase discontinuity between DMRS ports.

The wireless devices 205 may use a multi-port phase continuity reference signal waveform to estimate phase jump per-port. For example, in examples in which ports used for or associated with communication of DMRSs have phase discontinuity (e.g., do not have phase coherence), the wireless device 205-b may perform channel estimation to determine a phase jump per DMRS port (e.g., rather than for multiple or a group of DMRS ports). However, in some cases, DMRS ports may be coherent and, accordingly, may share a same phase continuity reference signal port to reduce complexity at the wireless devices 205. As such, techniques described herein support phase continuity reference signal port sharing and DMRS port-to-phase continuity reference signal port association. In other words, by associating DMRS ports with phase continuity reference signal ports, techniques described herein may support reduced complexity, reduced overhead, or both.

For example, the wireless devices 205 may support one or more different configurations (e.g., waveforms) for multi-port phase continuity reference signals 215. The wireless devices 205 may use (e.g., select, identify, determine, apply, etc.) a configuration based on coherence of DMRS ports per code division multiplexing (CDM) group. As used herein, a CDM group may refer to ports that are multiplexed with a CDM. By selecting the waveform based on the coherence of the DMRS ports, the wireless device 205-a may reduce overhead of the phase continuity reference signals 215. The phase continuity reference signals 215 may have a frequency density of one resource per X resource blocks. Accordingly, in a first example, when two DMRS ports that are frequency division multiplexed are coherent, the wireless device 205-a may transmit one phase continuity reference signal 215 via one port with an overhead of one resource element per X resource blocks. Alternatively, when the two DMRS ports are non-coherent, the wireless device 205-a may transmit two phase continuity reference signals 215 via two ports with an overhead of two resource elements per X resource blocks. In a second example, when two DMRS ports that are code division multiplexed are coherent, the wireless device 205-a may apply port repetition with an overhead of one resource element per X resource blocks. Alternatively, when the two DMRS ports are non-coherent, the wireless device 205-a may transmit two phase continuity reference signals 215 with a length-2 orthogonal cover code (OCC) and an overhead of two resource elements per X resource blocks.

The phase continuity reference signals 215 may be communicated in downlink and uplink scenarios. For example, the wireless device 205-a (e.g., the transmitting device) may be a network entity. In such examples, the network entity may determine the configuration (e.g., the phase continuity reference signal waveform) based on coherence of DMRS ports. The network entity may indicate the configuration, port indices, or both to the wireless device 205-b (e.g., a UE). Alternatively, the wireless device 205-a may be a UE. In such examples, the UE may indicate a port coherence capability, a configuration based on a coherence, or both to the wireless device 205-b (e.g., a network entity). The network entity may schedule the phase continuity reference signal 215 based on the indications from the UE.

The wireless devices 205 may identify or determine one or more phase coherence groups. A phase coherence group may include two or more ports that have phase coherence. That is, ports within a same phase coherence group may have phase coherence with other ports within the phase coherence group. In some cases, within a phase coherence group, the wireless device 205-a may transmit multiple phase continuity reference signals 215 via ports that are associated with active DMRS ports. However, communication of multiple phase continuity reference signals 215 for multiple coherent ports may be associated with large overhead. As such, within each port coherence group, the wireless devices 205 may exchange one or more phase continuity reference signals 215 using one or more ports (e.g., rather than all ports that correspond to DMRS ports having phase coherence).

The wireless devices 205 may exchange one or more control messages (e.g., RRC messages) to determine the phase coherence groups. For example, the one or more control messages may indicate information associated with phase coherence between DMRS ports. In uplink scenarios (e.g., when the wireless device 205-a is a UE), the wireless device 205-a may transmit a capability report. For example, the wireless device 205-a may transmit a capability report indicating a capability to support the configurations for multi-port phase continuity reference signals 215. In downlink scenarios (e.g., when the wireless device 205-b is a network entity), the wireless device 205-a may transmit an indication of DMRS ports that are coherent with each other. In other words, the wireless devices 205 may exchange capability information, coherence information, or both to determine phase coherence groups.

In some examples, phase continuity reference signal ports that are associated with active DMRS ports may be merged. As used herein, “merging” or “sharing” a port may refer to a single phase continuity reference signal port corresponding to or being associated with multiple DMRS ports. That is, the wireless devices 205 may use the single phase continuity reference signal port to perform phase estimation between multiple DMRS ports and corresponding phase continuity reference signal ports. Phase continuity reference signal ports may be merged or shared when two active DMRS ports (e.g., either FDM or CDM) form a coherence group.

The wireless devices 205 may select (e.g., keep) a phase continuity reference signal port having a lowest port index within the phase coherence group or a phase continuity reference signal port having a lowest port index in each CDM group within the coherence group. That is, the wireless devices 205 may use a phase continuity reference signal port with a lowest port index of multiple phase continuity reference signal ports that are associated with multiple coherent DMRS ports (e.g., in a phase coherence group). Alternatively, the wireless devices 205 may use one or more phase continuity reference signal ports with lowest port indices of multiple phase continuity reference signal ports that are associated with multiple coherent DMRS ports in one or more CDM groups. In other words, the wireless devices 205 may select phase continuity reference signal ports per phase coherence group (e.g., one per phase coherence group) or per CDM group (e.g., within each phase coherence group). In each implementation, the wireless devices 205 may support or apply power boosting.

Active DMRS ports within a coherence group may be associated with a selected phase continuity reference signal port. For example, a coherence group may include multiple active DMRS ports, and the selected phase continuity reference signal port may be associated with (e.g., be used to perform phase estimation for) the multiple active DMRS ports. As such, the wireless devices 205 may have a same or common understanding of which phase continuity reference signal ports are used and association of phase continuity reference signal ports to active DMRS ports. In the downlink scenario, the wireless device 205-a (e.g., the network entity) may schedule the shared channel 220 (e.g., the PDSCH) with one or more DMRS ports but also transmit the corresponding phase continuity reference signal ports (e.g., if applicable). The wireless device 205-b (e.g., the UE), in such examples, may determine the phase continuity reference signal ports, resources, or both, to process from the scheduled DMRS ports. In the uplink scenario, the wireless device 205-b (e.g., the network entity) may schedule the shared channel 220 (e.g., PUSCH) with one or more DMRS ports, and the wireless device 205-a (e.g., the UE) may determine the corresponding phase continuity reference signal ports, configuration, or both to be transmitted from the scheduled DMRS ports (e.g., if applicable).

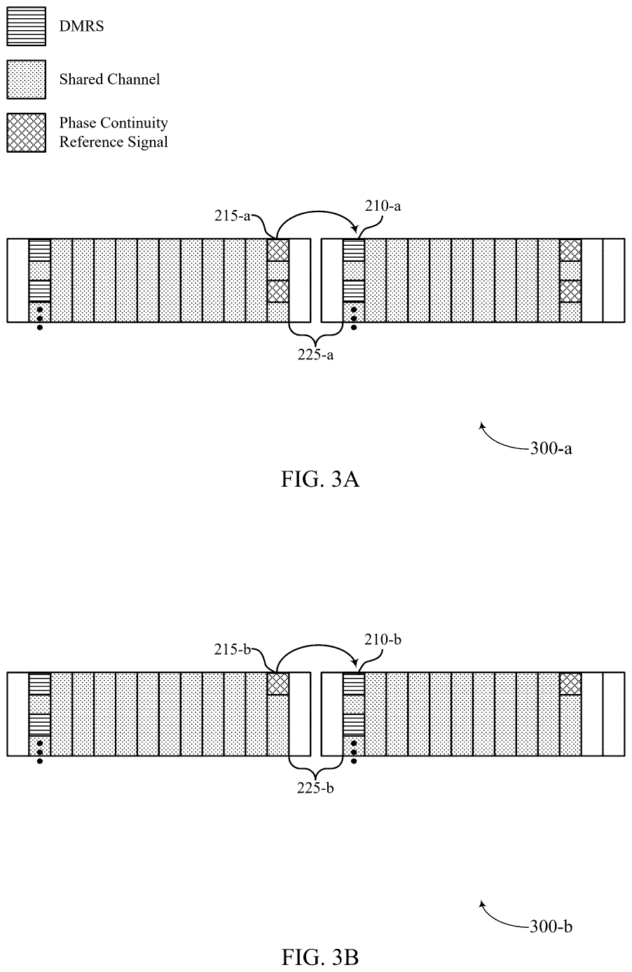

The wireless devices 205 may select a configuration for the phase continuity reference signals 215 based on coherence within CDM groups. For example, the wireless devices 205 may select a first configuration based on the DMRS ports within a CDM group not being coherent. Alternatively, the wireless devices 205 may select a second configuration based on the DMRS ports within a CDM group being coherent. The first configuration and the second configuration may be described in greater detail elsewhere herein, including with reference to FIGS. 3A and 3B.

In addition to or alternatively from communicating the one or more control messages indicating the capability, phase coherence, or both, the wireless devices 205 may use control information to directly indicate the configuration. For example, the wireless devices 205 may communicate uplink control information (UCI) or downlink control information (DCI) that includes an indication of the configuration (e.g., the phase continuity reference signal waveform), phase continuity reference signal ports transmitted or to be transmitted, or both. Additionally, or alternatively, the UCI or DCI may indicate the active phase continuity reference signal ports (e.g., the phase continuity reference signal ports to be used), the configuration (e.g., the phase continuity reference signal waveform), and a DMRS-to-phase continuity reference signal port mapping based on a phase coherence of the wireless device 205-a (e.g., the transmitting device).

In uplink scenarios, the wireless device 205-a (e.g., the UE) may indicate a coherence capability in the UCI. For example, the wireless device 205-a may indicate the coherence capability if not previously indicated to the wireless device 205-b. In downlink scenarios, the wireless device 205-a (e.g., the network entity) may indicate the waveform based on DMRS port coherence.

The wireless device 205-a may select the configuration per CDM group based on the active DMRS ports. For example, if a DMRS port within a CDM group is non-coherent with at least one other DMRS port of the CDM group, the wireless device 205-a may select the first configuration (e.g., described with reference to FIG. 3A). Alternatively, if the DMRS ports within a CDM group are coherent, the wireless device 205-a may select the second configuration (e.g., described with reference to FIG. 3B).

The wireless device 205-a may form one or more phase coherence groups. Within each phase coherence group, the wireless device 205-a may select a phase continuity reference signal port for transmission of the phase continuity reference signal 215. The wireless device 205-a may signal (e.g., in DCI or UCI) the active phase continuity reference signal ports, the configuration (e.g., waveform), and the DMRS-to-phase continuity reference signal port mapping.

An example of a DMRS-to-phase continuity reference signal port mapping is demonstrated with reference to Table 1.

TABLE 1

| DMRS Port Number | 0 | 1 | 2 | 3 |
|---|---|---|---|---|
| Phase Continuity Reference Signal | 0 | 0 | 2 | 2 |
| Port Index | | | | |

The DCI or UCI may include phase continuity reference signal port indices mapped to each active DMRS port. For each active DMRS port, the DCI or UCI may include a corresponding field that indicates the associated phase continuity reference signal port index. As an example, for 4 active DMRS ports, the DCI or UCI may include a 2-bit field for each DMRS port to indicate the corresponding phase continuity reference signal port and a codepoint to indicate a configuration (e.g., waveform). If a phase continuity reference signal index is absent from the indicated phase continuity reference signal port indices, the phase continuity reference signal 215 may not be transmitted.

FIG. 3A shows an example of a resource diagram 300-a that supports multi-port phase continuity reference signals in accordance with one or more aspects of the present disclosure. Aspects of the resource diagram 300-a may be implemented by the wireless communications system 100 and the wireless communications system 200, as described herein. In some implementations, the resource diagram 300-a may be implemented by wireless devices, such as the wireless devices 205.

The wireless devices as described with reference to FIG. 2 may select a configuration for phase continuity reference signals based on coherence within CDM groups. For example, the wireless devices may select a first configuration based on the DMRS ports within a CDM group not being coherent. The first configuration may be an example of or implement the resource diagram 300-a as described with reference to FIG. 3A.

In examples in which multiple DMRS ports do not have phase coherence, a receiving device may estimate independent phase jump per-DMRS port. That is, in an example in which a first DMRS port and a second DMRS port do not have phase coherence, the first DMRS port and the second DMRS port may have independent phase jumps. In such examples, a multi-port phase continuity reference signal structure may share a DMRS waveform structure such that, if a DMRS 210-a is proximate to (e.g., close to) a phase jump boundary 225-a, the DMRS 210-a may be used as a phase continuity reference signal. By using the DMRS 210-a as the phase continuity reference signal, the wireless devices may reduce overhead (e.g., support overhead saving).

In examples in which a first DMRS port does not have phase coherence with a second DMRS port, and where the first DMRS port and the second DMRS ports are frequency division multiplexed (e.g., two non-coherent FDM DMRS ports), the wireless devices may be configured with two frequency division multiplexed phase continuity reference signal ports. That is, the wireless devices may communicate phase continuity reference signals 215-a, including a first phase continuity reference signal and a second phase continuity reference signal, where the first phase continuity reference signal and the second phase continuity reference signal are frequency division multiplexed.

Additionally, in such examples, the wireless devices 205 may select (e.g., choose) per-port phase continuity reference signals independently. For example, the phase continuity reference signal waveform per port (e.g., FDM port) may be based on a phase continuity reference signal waveform in an associated code CDM group. A CDM group may refer to two or more ports that are code division multiplexed. Within a CDM group, the phase continuity reference signal 215-a may have different waveform types. In the example of FIG. 3A, the phase continuity reference signal waveform may include per-port phase continuity reference signals with multiple resource elements per multiple resource blocks. In other words, the waveform may include M resource elements per X resource blocks. Additionally, the waveform may include application of time division or frequency division OCC multiplexing. In such examples, the wireless device 205-b may estimate per-port phase jump independently within the CDM group. That is, the wireless device 205-b may estimate the per-port phase jump for individual ports pairings within the CDM group.

The phase continuity reference signals 215-a that are communicated before the phase jump boundary 225-a may be defined by Equation 1 and Equation 2 below, where Equation 1 corresponds to a first phase continuity reference signal in a first port (e.g., port 0) and Equation 2 corresponds to a second phase continuity reference signal in a second port (e.g., port 1). In Equations 1 and 2, y₀ is a received signal in a first phase continuity reference signal tone, and y₁ is a received signal in a second phase continuity reference signal tone (e.g., adjacent to the first phase continuity reference signal tone).

$${y}_{0} = ( {H}_{0 , j} {x}_{0 , k} + {H}_{1 , j} {x}_{1 , k} ) \qquad ( 1 )$$

$${y}_{1} = ( {H}_{0 , j} {x}_{0 , k} - {H}_{1 , j} {x}_{1 , k} ) \qquad ( 2 )$$

A receiving device may obtain a signal r₀ in a first port by a summation of y₀ and y₁. Additionally, the receiving device may obtain a signal r₁ in a second port by a subtraction of y₁ from y₀.

The DMRSs 210-a that are communicated after the phase jump boundary 225-a may be defined by Equation 3 and Equation 4 below, where Equation 3 corresponds to a first DMRS in the first port (e.g., port 0) and Equation 4 corresponds to a second DMRS in a second port (e.g., port 1). In Equations 3 and 4,

$${y}_{0}^{′}$$

is a received signal in a first DMRS tone, and

$${y}_{1}^{′}$$

is a received signal in a second DMRS tone (e.g., adjacent to the first DMRS tone).

$${y}_{0}^{′} = ( {e}^{j Δ {θ}_{0}} {H}_{0 , j} {x}_{0 , k}^{′} + {e}^{j Δ {θ}_{1}} {H}_{1 , j} {x}_{1 , k}^{′} ) \qquad ( 3 )$$

$${y}_{1}^{′} = ( {e}^{j Δ {θ}_{0}} {H}_{0 , j} {x}_{0 , k}^{′} - {e}^{j Δ {θ}_{1}} {H}_{1 , j} {x}_{1 , k}^{′} ) \qquad ( 4 )$$

The receiving device may obtain a signal

$${r}_{0}^{′}$$

of the first port across the phase jump boundary 225-a by a summation of

$${y}_{0}^{′} and {y}_{1}^{′} .$$

Additionally, the receiving device may obtain a signal

$${r}_{1}^{′}$$

in a second port by a subtraction of

$${y}_{1}^{′}$$

from

$${y}_{0}^{′} .$$

The receiving device may determine a phase jump of the first port by comparing the signal r₀ to the signal

$${r}_{0}^{′}$$

and a phase jump of the second port by comparing the signal r₁ to the signal

$${r}_{1}^{′}$$

(e.g., by comparing the received signals before and after the phase jump boundary 225-a).

Wireless devices may select the first configuration corresponding to the resource diagram 300-a in examples in which DMRS ports within a CDM group are not coherent. For example, when DMRS ports (e.g., configured, scheduled, or active DMRS ports) in a CDM group are non-coherent or partial coherent, wireless devices may select a configuration including a first port and a second port (e.g., phase continuity reference signal ports) that correspond to a third port and a fourth port (e.g., DMRS ports).

FIG. 3B shows an example of a resource diagram 300-b that supports multi-port phase continuity reference signals in accordance with one or more aspects of the present disclosure. Aspects of the resource diagram 300-b may be implemented by the wireless communications system 100 and the wireless communications system 200, as described herein. In some implementations, the resource diagram 300-b may be implemented by wireless devices, such as the wireless devices 205.

The wireless devices as described with reference to FIG. 2 may select a configuration for phase continuity reference signals based on coherence within CDM groups. For example, the wireless devices may select a second configuration based on DMRS ports within a CDM group being coherent. The second configuration may be an example of or implement the resource diagram 300-b as described with reference to FIG. 3B.

In an example in which a CDM group includes coherent DMRS ports, a phase continuity reference signal waveform may include a single port phase continuity reference signal with a single resource element per multiple resource blocks. In other words, the waveform may include 1 resource element per X resource blocks. In such examples, the wireless devices may select a resource element occupied by a CDM DMRS for every x resource block of the X resource blocks. A transmitting device may transmit the phase continuity reference signal 215-b on the resource element.

In some examples, the transmitting device may transmit the phase continuity reference signal via the single port in a post-CDM fashion. In such examples, the transmitting device may repeat the phase continuity reference signal 215-b in active CDM DMRS ports with additional +1 or −1 scrambling. In some other examples, the wireless device may transmit the phase continuity reference signal 215-b in one of the DMRS ports in the CDM group. In such examples, to compare the phase jump across a phase jump boundary 225-b with another DMRS, the wireless device 205-b may perform channel estimation on a DMRS 210-b to estimate the channel of the associated DMRS port.

The phase continuity reference signal 215-b that is communicated before the phase jump boundary 225-b may be defined by Equation 5 below in examples in which the phase continuity reference signal 215-b is repeated in two ports. For example, Equation 5 may be an expression of the phase continuity reference signal 215-b that is transmitted in a first port (e.g., port 0) and in a second port (e.g., port 1). The receiving device may obtain a signal r₀ and a signal r₁ from yₖ corresponding to the first port and the second port, respectively.

$${y}_{k} = ( {H}_{0 , j} + {H}_{1 , j} ) \cdot {x}_{k} \qquad ( 5 )$$

Alternatively, the phase continuity reference signal 215-b that is communicated before the phase jump boundary 225-b may be defined by Equation 6 below in examples in which the phase continuity reference signal 215-b is transmitted in a single port. For example, Equation 6 may be an expression of the phase continuity reference signal 215-b that is transmitted in a first port (e.g., port 0). The receiving device may obtain a signal r from yₖ, where r may be approximated as a received signal in the first port and a second port (e.g., port 1).

$${y}_{k} = ( {H}_{0 , j} ) \cdot {x}_{k} \qquad ( 6 )$$

The DMRSs 210-b that are communicated after the phase jump boundary 225-b may be defined by Equation 7 and Equation 8 below, where Equation 7 corresponds to a first DMRS in the first port (e.g., port 0) and Equation 8 corresponds to a second DMRS in a second port (e.g., port 1). The receiving device may obtain a signal

$${r}_{0}^{′}$$

and a signal

$${r}_{1}^{′}$$

from yₖ′ and yₖ₊₁′, respectively, corresponding to the first port and the second port.

$${y}_{k}^{′} = {e}^{j Δ θ} ( {H}_{0 , j} + {H}_{1 , j} ) \cdot {x}_{k}^{′} \qquad ( 7 )$$

$${y}_{k + 1}^{′} = {e}^{j Δ θ} ( {H}_{0 , j} - {H}_{1 , j} ) \cdot {x}_{k}^{′} \qquad ( 8 )$$

The receiving device may determine a phase jump of the first port by comparing the signal r₀ (e.g., or r) to the signal

$${r}_{0}^{′}$$

and a phase jump of the second port by comparing the signal r₁ (e.g., or r) to the signal

$${r}_{1}^{′}$$

(e.g., by comparing the received signals before and after the phase jump boundary 225-b).

Wireless devices may select the second configuration corresponding to the resource diagram 300-b in examples in which DMRS ports within a CDM group are coherent. For example, when DMRS ports (e.g., configured, scheduled, or active DMRS ports) in a CDM group are coherent, wireless devices may select a configuration including, in the example of Equation 5, a first port and a second port (e.g., phase continuity reference signal ports) or, in the example of Equation 6, a first port. The first port and the second port or the first port may correspond to a third port and a fourth port (e.g., DMRS ports).

In some examples, the wireless devices may select a configuration based on active DMRS ports. As an example, when two configured DMRS ports that are code division multiplexed are non-coherent, but only one of the configured DMRS ports is active, the wireless devices may select the second configuration (e.g., rather than the first configuration).

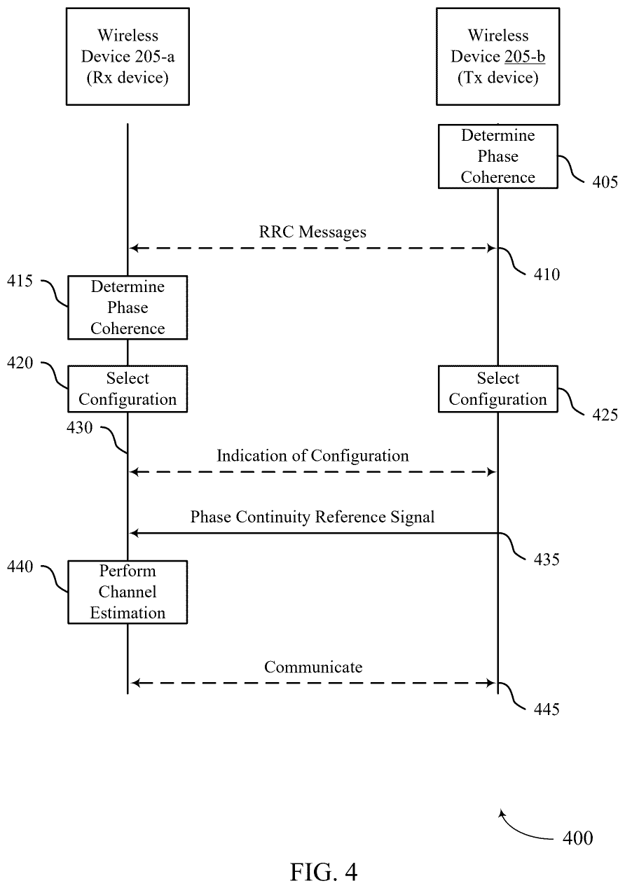

FIG. 4 shows an example of a process flow 400 that supports multi-port phase continuity reference signals in accordance with one or more aspects of the present disclosure. The process flow 400 may implement or be implemented by aspects of the wireless communications system 100, the wireless communications system 200, the resource diagram 300-a, the resource diagram 300-b, or any combination thereof. For example, the process flow 400 may include a wireless device 205-a (e.g., a receiving device) and a wireless device 205-b (e.g., a transmitting device), which may be examples of corresponding devices as described with reference to FIGS. 1 and 2.

Alternative examples of the following may be implemented, where some operations are performed in a different order than described or are not performed at all. In some cases, operations may include additional features not mentioned below, or further operations may be added. Although the wireless device 205-a and the wireless device 205-b are shown performing the operations of the process flow 400, some aspects of some operations may also be performed by one or more other wireless devices.

At 405, the wireless device 205-b may determine phase coherence. For example, the wireless device 205-b may determine a phase coherence between a first port and a second port. The first port and the second port may be examples of the ports discussed with reference to FIGS. 2, 3A, and 3B. For example, the first port and the second port may be examples of ports associated with communication of phase continuity reference signals, DMRSs, or both.

At 410, the wireless device 205-a and the wireless device 205-b may communicate one or more RRC messages. For example, the wireless device 205-b may communicate (e.g., output or transmit) one or more RRC messages indicating the phase coherence. In some examples, the wireless device 205-b may output the one or more RRC messages indicating the phase coherence based on determining the phase coherence at 405. The one or more RRC messages may include a capability report (e.g., for the wireless device 205-a, the wireless device 205-b, or both), an indication of one or more coherent ports, or both.

At 415, the wireless device 205-a may determine phase coherence. For example, the wireless device 205-a may determine a phase coherence between a first port and a second port. In some examples, the wireless device 205-a may determine the phase coherence based on the one or more RRC messages exchanged at 410.

At 420 and at 425, the wireless device 205-a and the wireless device 205-a, respectively, may select a configuration. For example, the wireless device 205-a and the wireless device 205-b may select a configuration for phase continuity reference signals based on the phase coherence between the first port and the second port determined at 405 and at 415, respectively. The configuration may include an association between one or more first ports associated with communication of DMRSs (e.g., DMRS ports) and one or more second ports associated with communication of the phase continuity reference signals (e.g., phase continuity reference signal ports).

In some examples, selecting the configuration may involve selecting ports associated with the communication of the phase continuity reference signals. For example, the wireless device 205-a, the wireless device 205-b, or both may identify one or more phase coherence groups based on the phase coherence between the first port and the second port (e.g., determined at 405 and 415). Each port coherence group may include first ports associated with the communication of the DMRSs, where the first ports correspond to second ports associated with the communication of the phase continuity reference signals. The wireless device 205-a, the wireless device 205-b, or both may select, for each phase coherence group, a respective port of the second ports (e.g., the phase continuity reference signal ports) having a lowest port index. In other words, the wireless device 205-a, the wireless device 205-b, or both may select a phase continuity reference signal port with a lowest port index within the coherence group.

Alternatively, each phase coherence group may include one or more CDM groups, where each CDM group includes the first ports associated with the communication of DMRSs, and where the first ports correspond to the second ports associated with the communication of the phase continuity reference signals. The wireless device 205-a, the wireless device 205-b, or both may select, for each CDM group of the one or more CDM groups of each phase coherence group, a port of the second ports having a lowest port index. In other words, the wireless device 205-a, the wireless device 205-b, or both may select a phase continuity reference signal port with a lowest port index in each CDM group within the coherence group.

In examples in which one or more ports associated with the communication of the DMRSs in a CDM group are non-coherent or partial coherent, the configuration may include at least two ports associated with the communication of the phase continuity reference signals and corresponding ports associated with the communication of the DMRSs. That is, the configuration may include a third port and a fourth port associated with the communication of the phase continuity reference signals, the third port and the fourth port being associated with a fifth port and a sixth port of the one or more ports (e.g., associated with the communication of the DMRSs). In such examples, a first phase continuity reference signal may be communicated via a first resource element associated with the third port, and a second phase continuity reference signal may be communicated via a second resource element associated with the fourth port. In other words, when ports associated with the communication of the DMRSs in a CDM group are non-coherent or partial coherent, the wireless device 205-a and the wireless device 205-b may select a configuration corresponding to the communication illustrated and described with respect to FIG. 3A. In some examples, the one or more ports associated with the communication of the DMRSs may be active DMRS ports.

In examples in which one or more ports associated with the communication of the DMRSs in a CDM group are coherent, the configuration may include one or two ports associated with the communication of the phase continuity reference signals and corresponding ports associated with the communication of the DMRSs. That is, the configuration may include a third port and a fourth port associated with the communication of the phase continuity reference signals, the third port and the fourth port being associated with a fifth port and a sixth port of the one or more ports. Alternatively, the configuration may include the third port associated with the communication of the phase continuity reference signals, the third port having the association with the fifth port and the sixth port. In such examples, a first phase continuity reference signal may be communicated via a first resource element associated with the third port and the fourth port or associated with the third port. In other words, when ports associated with the communication of the DMRSs in a CDM group are non-coherent or partial coherent, the wireless device 205-a and the wireless device 205-b may select a configuration corresponding to the communication illustrated and described with respect to FIG. 3B. In some examples, the one or more ports associated with the communication of the DMRSs may be active DMRS ports.

In some examples, the wireless device 205-a, the wireless device 205-b, or both may select the configuration per CDM group. That is, the configuration may be associated with a CDM group. As an example, the wireless device 205-a, the wireless device 205-b, or both may select a configuration corresponding to the example of FIG. 3A for a first CDM group and a configuration corresponding to the example of FIG. 3B for a second CDM group.

At 430, the wireless device 205-a and the wireless device 205-b may communicate an indication of the configuration. For example, the wireless device 205-a and the wireless device 205-b may communicate a control message indicative of the configuration for the phase continuity reference signals based on the phase coherence between the first port and the second port. In such examples, the wireless device 205-a may receive and the wireless device 205-b may transmit the one or more phase continuity reference signals is based on the control message. The control message may include a mapping of the one or more first ports associated with the communication of the DMRSs to the one or more second ports associated with the communication of the phase continuity reference signals, where the one or more first ports include active DMRS ports.

The control message may be an example of a DCI or UCI. For example, when the phase continuity reference signals are transmitted via a downlink communications link (e.g., the wireless device 205-b is a network entity and the wireless device 205-a is a UE), the control message may be a DCI. Alternatively, when the phase continuity reference signals are transmitted via an uplink communications link (e.g., the wireless device 205-b is a UE and the wireless device 205-a is a network entity), the control message may be a UCI. In examples in which the phase continuity reference signals are transmitted via an uplink communications link, the wireless device 205-b (e.g., a UE) may transmit a UCI message indicative of a capability of the UE to adjust the phase coherence. In other words, the UE may indicate a phase coherence capability to the network entity.

At 435, the wireless device 205-b may output a phase continuity reference signal. For example, the wireless device 205-a may receive, and the wireless device 205-b may transmit, one or more phase continuity reference signals in accordance with the configuration, the one or more phase continuity reference signals associated with estimation of a phase discontinuity between the first port and the second port.

In some examples, the wireless device 205-a may receive the one or more phase continuity reference signals via the one or more second ports including the second port in accordance with the configuration, where the one or more second ports are associated with the one or more first ports that include one or more active DMRS ports. In other words, the wireless device 205-b may transmit the phase continuity reference signals via multiple phase continuity reference signal ports associated with active DMRS ports within a port coherence group.

At 440, the wireless device 205-a may perform channel estimation. For example, the wireless device 205-a may perform channel estimation for the first port and the second port in accordance with the one or more phase continuity reference signals received at 435.

At 445, the wireless device 205-a and the wireless device 205-b may communicate. For example, the wireless device 205-a, the wireless device 205-b, or both may adjust one or more communications parameters based on the channel estimation. The wireless device 205-a, the wireless device 205-b, or both may communicate using the adjusted communications parameters.

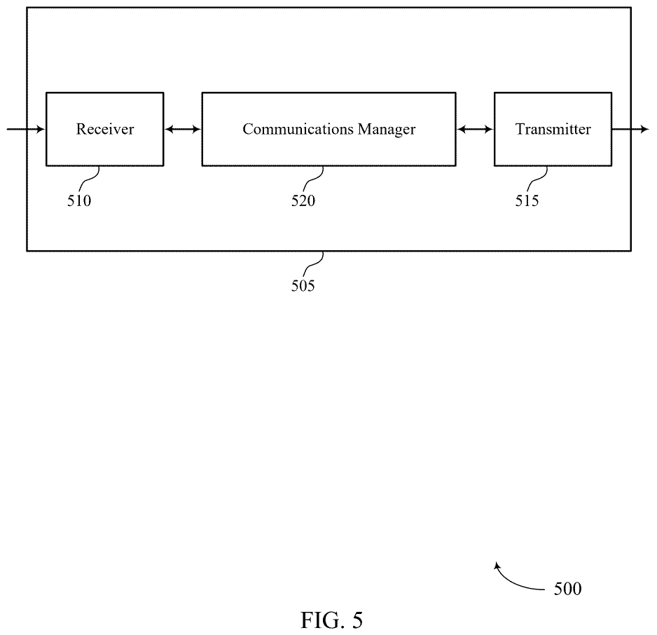

FIG. 5 shows a block diagram 500 of a device 505 that supports multi-port phase continuity reference signals in accordance with one or more aspects of the present disclosure. The device 505 may be an example of aspects of a receiving device as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of multi-port phase continuity reference signals as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for determining a phase coherence between a first port and a second port. The communications manager 520 is capable of, configured to, or operable to support a means for selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The communications manager 520 is capable of, configured to, or operable to support a means for receiving one or more phase continuity reference signals in accordance with the configuration, the one or more phase continuity reference signals associated with estimation of a phase discontinuity between the first port and the second port. The communications manager 520 is capable of, configured to, or operable to support a means for performing channel estimation for the first port and the second port in accordance with the one or more phase continuity reference signals.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

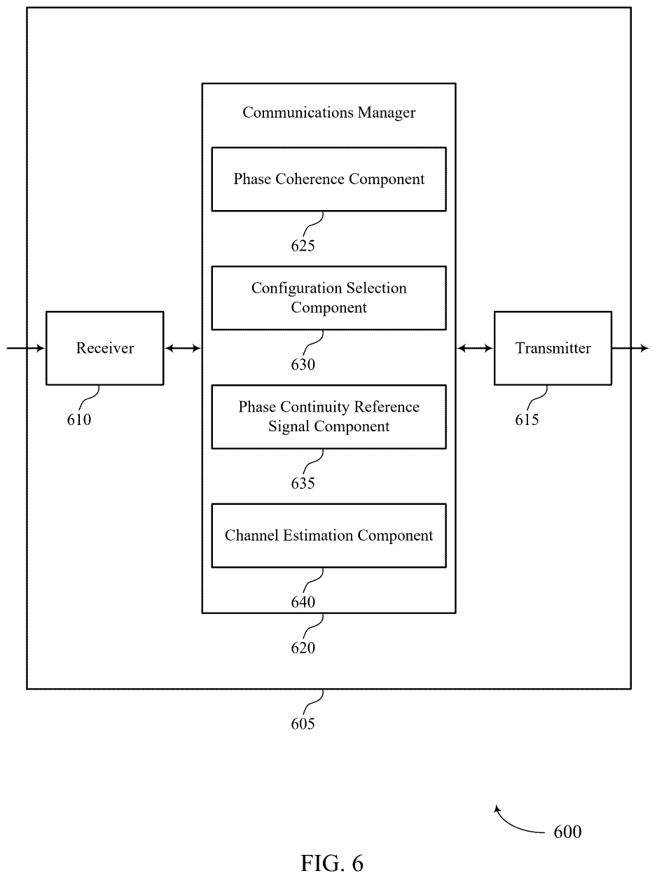

FIG. 6 shows a block diagram 600 of a device 605 that supports multi-port phase continuity reference signals in accordance with one or more aspects of the present disclosure. The device 605 may be an example of aspects of a device 505 or a receiving device (e.g., a UE 115 or a network entity 105) as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of multi-port phase continuity reference signals as described herein. For example, the communications manager 620 may include a phase coherence component 625, a configuration selection component 630, a phase continuity reference signal component 635, a channel estimation component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The phase coherence component 625 is capable of, configured to, or operable to support a means for determining a phase coherence between a first port and a second port. The configuration selection component 630 is capable of, configured to, or operable to support a means for selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The phase continuity reference signal component 635 is capable of, configured to, or operable to support a means for receiving one or more phase continuity reference signals in accordance with the configuration, the one or more phase continuity reference signals associated with estimation of a phase discontinuity between the first port and the second port. The channel estimation component 640 is capable of, configured to, or operable to support a means for performing channel estimation for the first port and the second port in accordance with the one or more phase continuity reference signals.

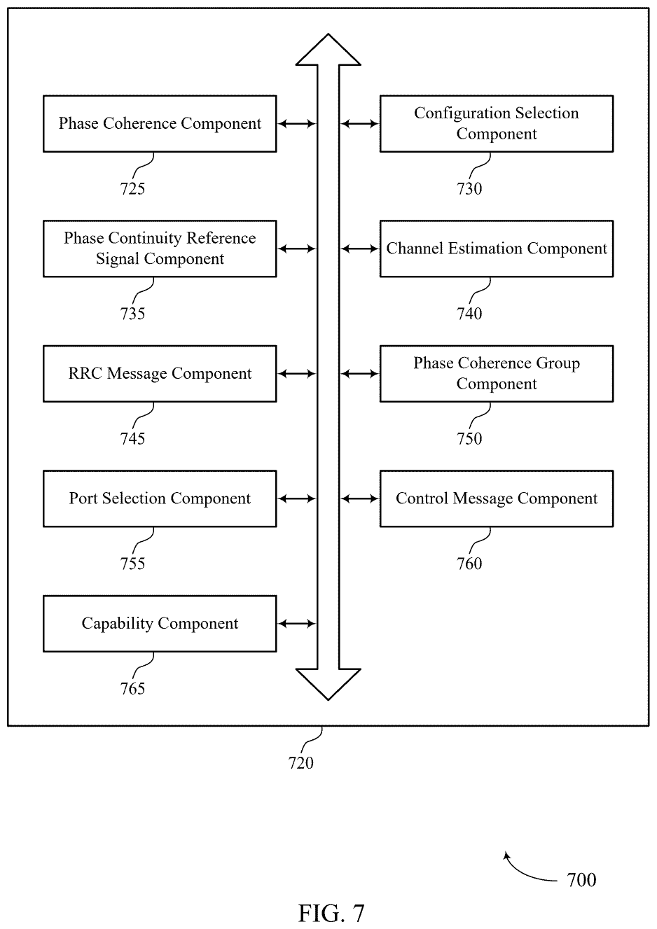

FIG. 7 shows a block diagram 700 of a communications manager 720 that supports multi-port phase continuity reference signals in accordance with one or more aspects of the present disclosure. The communications manager 720 may be an example of aspects of a communications manager 520, a communications manager 620, or both, as described herein. The communications manager 720, or various components thereof, may be an example of means for performing various aspects of multi-port phase continuity reference signals as described herein. For example, the communications manager 720 may include a phase coherence component 725, a configuration selection component 730, a phase continuity reference signal component 735, a channel estimation component 740, an RRC message component 745, a phase coherence group component 750, a port selection component 755, a control message component 760, a capability component 765, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The phase coherence component 725 is capable of, configured to, or operable to support a means for determining a phase coherence between a first port and a second port. The configuration selection component 730 is capable of, configured to, or operable to support a means for selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The phase continuity reference signal component 735 is capable of, configured to, or operable to support a means for receiving one or more phase continuity reference signals in accordance with the configuration, the one or more phase continuity reference signals associated with estimation of a phase discontinuity between the first port and the second port. The channel estimation component 740 is capable of, configured to, or operable to support a means for performing channel estimation for the first port and the second port in accordance with the one or more phase continuity reference signals.

In some examples, the RRC message component 745 is capable of, configured to, or operable to support a means for receiving one or more RRC messages indicating the phase coherence, where determining the phase coherence between the first port and the second port is based on the one or more RRC messages.

In some examples, the one or more RRC messages include a capability report, an indication of one or more coherent ports, or both.

In some examples, the one or more phase continuity reference signals are received via the one or more second ports including the second port in accordance with the configuration, the one or more second ports associated with the one or more first ports that include one or more active DMRS ports.

In some examples, the phase coherence group component 750 is capable of, configured to, or operable to support a means for identifying one or more phase coherence groups based on the phase coherence between the first port and the second port, where: each phase coherence group of the one or more phase coherence groups includes a first set of multiple ports associated with the communication of the DMRSs, and the first set of multiple ports correspond to a second set of multiple ports associated with the communication of the phase continuity reference signals. In some examples, the port selection component 755 is capable of, configured to, or operable to support a means for selecting, for each phase coherence group of the one or more phase coherence groups, a respective port of the second set of multiple ports having a lowest port index.

In some examples, the phase coherence group component 750 is capable of, configured to, or operable to support a means for identifying one or more phase coherence groups based on the phase coherence between the first port and the second port, where: each phase coherence group of the one or more phase coherence groups includes one or more CDM groups, each CDM group of the one or more CDM groups includes a first set of multiple ports associated with the communication of the DMRSs, and the first set of multiple ports correspond to a second set of multiple ports associated with the communication of the phase continuity reference signals. In some examples, the port selection component 755 is capable of, configured to, or operable to support a means for selecting, for each CDM group of the one or more CDM groups of each phase coherence group, a respective port of the second set of multiple ports having a lowest port index of the second set of multiple ports.

In some examples, to support, based on one or more ports associated with the communication of the DMRSs in a CDM group being non-coherent or partial coherent, the configuration, the phase continuity reference signal component 735 is capable of, configured to, or operable to support a means for receiving a first phase continuity reference signal via a first resource element associated with the third port. In some examples, to support, based on one or more ports associated with the communication of the DMRSs in a CDM group being non-coherent or partial coherent, the configuration, the phase continuity reference signal component 735 is capable of, configured to, or operable to support a means for receiving a second phase continuity reference signal via a second resource element associated with the fourth port.

In some examples, the one or more ports associated with the communication of the DMRSs include active DMRS ports.

In some examples, to support, based on one or more ports associated with the communication of the DMRSs in a CDM group being coherent, the configuration, the phase continuity reference signal component 735 is capable of, configured to, or operable to support a means for receiving a first phase continuity reference signal via a first resource element associated with the third port and the fourth port or associated with the third port.

In some examples, the one or more ports associated with the communication of the DMRSs include active DMRS ports.

In some examples, the configuration for the phase continuity reference signals is associated with a CDM group.

In some examples, the control message component 760 is capable of, configured to, or operable to support a means for communicating a control message indicative of the configuration for the phase continuity reference signals based on the phase coherence between the first port and the second port, where receiving the one or more phase continuity reference signals is based on the control message.

In some examples, the control message includes a mapping of the one or more first ports associated with the communication of the DMRSs to the one or more second ports associated with the communication of the phase continuity reference signals. In some examples, the one or more first ports include active DMRS ports.

In some examples, the capability component 765 is capable of, configured to, or operable to support a means for receiving an UCI message indicative of a capability of a UE to adjust the phase coherence.

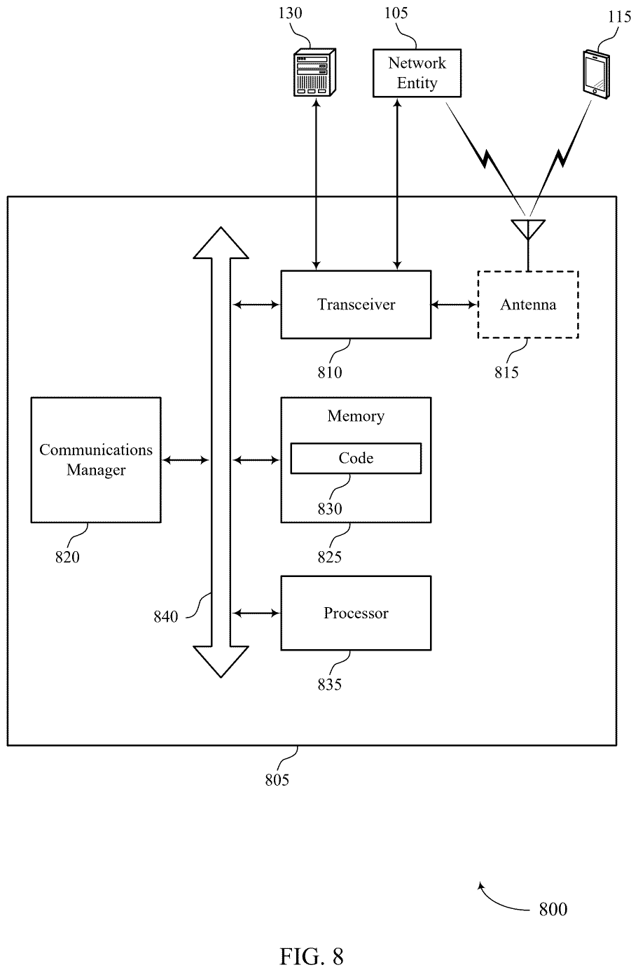

FIG. 8 shows a diagram of a system 800 including a device 805 that supports multi-port phase continuity reference signals in accordance with one or more aspects of the present disclosure. The device 805 may be an example of or include components of a device 505, a device 605, or a receiving device as described herein. The device 805 may include components for bi-directional voice and data communications including components for transmitting and receiving communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting multi-port phase continuity reference signals). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for determining a phase coherence between a first port and a second port. The communications manager 820 is capable of, configured to, or operable to support a means for selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The communications manager 820 is capable of, configured to, or operable to support a means for receiving one or more phase continuity reference signals in accordance with the configuration, the one or more phase continuity reference signals associated with estimation of a phase discontinuity between the first port and the second port. The communications manager 820 is capable of, configured to, or operable to support a means for performing channel estimation for the first port and the second port in accordance with the one or more phase continuity reference signals.

By including or configuring the communications manager 820 in accordance with examples as described herein, the device 805 may support techniques for more efficient utilization of communication resources.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of multi-port phase continuity reference signals as described herein, or the at least one processor 835 and the at least one memory 825 may be otherwise configured to, individually or collectively, perform or support such operations.

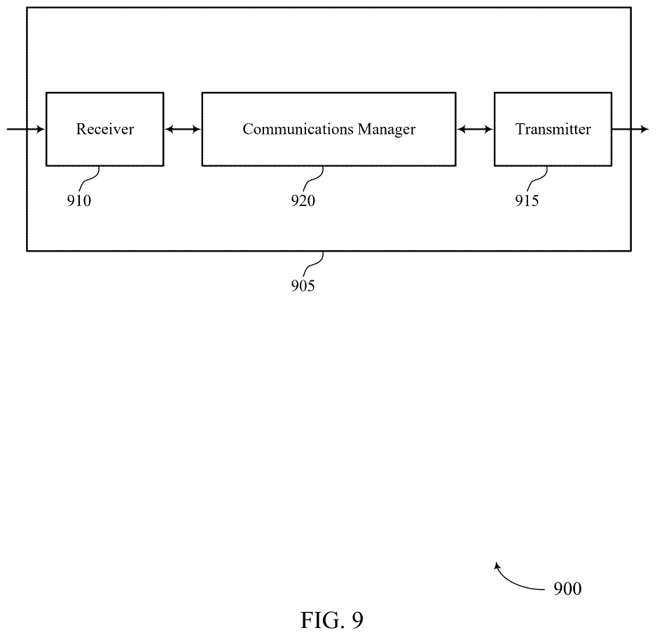

FIG. 9 shows a block diagram 900 of a device 905 that supports multi-port phase continuity reference signals in accordance with one or more aspects of the present disclosure. The device 905 may be an example of aspects of a transmitting device as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of multi-port phase continuity reference signals as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for determining a phase coherence between a first port and a second port. The communications manager 920 is capable of, configured to, or operable to support a means for selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The communications manager 920 is capable of, configured to, or operable to support a means for transmitting one or more phase continuity reference signals in accordance with the configuration, the one or more phase continuity reference signals associated with estimation of a phase discontinuity between the first port and the second port.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

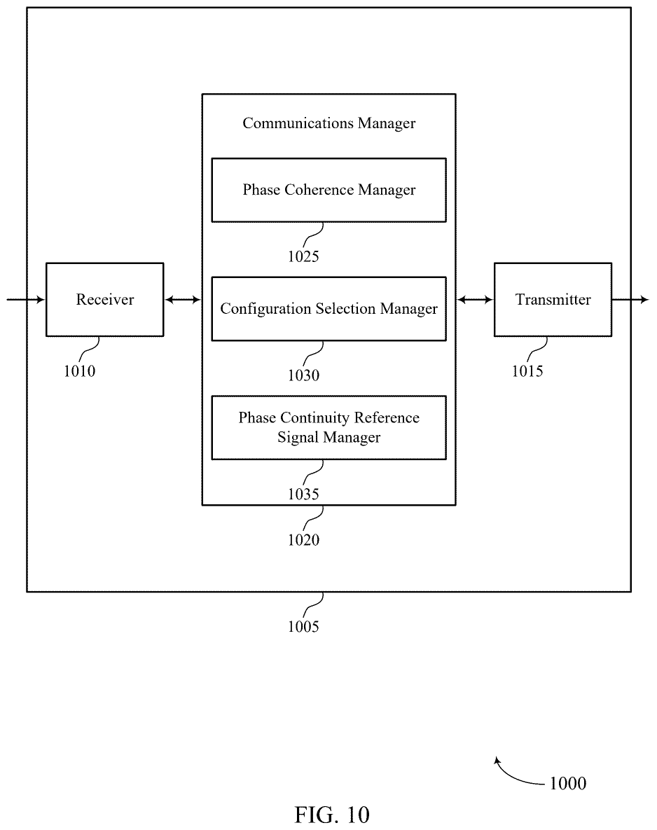

FIG. 10 shows a block diagram 1000 of a device 1005 that supports multi-port phase continuity reference signals in accordance with one or more aspects of the present disclosure. The device 1005 may be an example of aspects of a device 905 or a transmitting device (e.g., a UE 115 or a network entity 105) as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of multi-port phase continuity reference signals as described herein. For example, the communications manager 1020 may include a phase coherence manager 1025, a configuration selection manager 1030, a phase continuity reference signal manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The phase coherence manager 1025 is capable of, configured to, or operable to support a means for determining a phase coherence between a first port and a second port. The configuration selection manager 1030 is capable of, configured to, or operable to support a means for selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The phase continuity reference signal manager 1035 is capable of, configured to, or operable to support a means for transmitting one or more phase continuity reference signals in accordance with the configuration, the one or more phase continuity reference signals associated with estimation of a phase discontinuity between the first port and the second port.

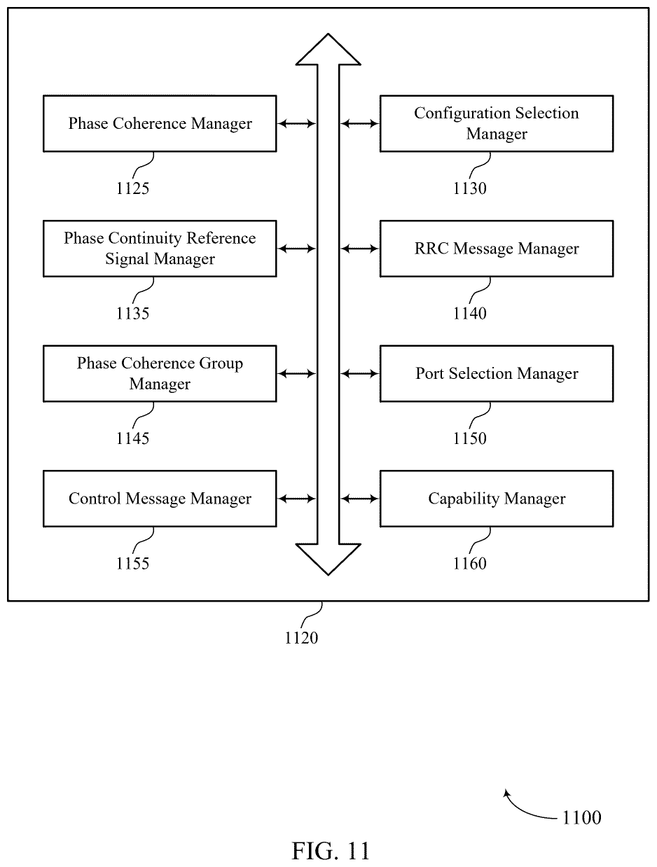

FIG. 11 shows a block diagram 1100 of a communications manager 1120 that supports multi-port phase continuity reference signals in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of multi-port phase continuity reference signals as described herein. For example, the communications manager 1120 may include a phase coherence manager 1125, a configuration selection manager 1130, a phase continuity reference signal manager 1135, an RRC message manager 1140, a phase coherence group manager 1145, a port selection manager 1150, a control message manager 1155, a capability manager 1160, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The phase coherence manager 1125 is capable of, configured to, or operable to support a means for determining a phase coherence between a first port and a second port. The configuration selection manager 1130 is capable of, configured to, or operable to support a means for selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The phase continuity reference signal manager 1135 is capable of, configured to, or operable to support a means for transmitting one or more phase continuity reference signals in accordance with the configuration, the one or more phase continuity reference signals associated with estimation of a phase discontinuity between the first port and the second port.

In some examples, the RRC message manager 1140 is capable of, configured to, or operable to support a means for communicating one or more RRC messages indicating the phase coherence, where determining the phase coherence between the first port and the second port is based on the one or more RRC messages.

In some examples, the one or more RRC messages include a capability report, an indication of one or more coherent ports, or both.

In some examples, the one or more phase continuity reference signals are transmitted via the one or more second ports including the first port in accordance with the configuration, the one or more second ports associated with the one or more first ports that include one or more active DMRS ports.

In some examples, the phase coherence group manager 1145 is capable of, configured to, or operable to support a means for identifying one or more phase coherence groups based on the phase coherence between the first port and the second port, where: each phase coherence group of the one or more phase coherence groups includes a first set of multiple ports associated with the communication of the DMRSs, and the first set of multiple ports correspond to a second set of multiple ports associated with the communication of the phase continuity reference signals. In some examples, the port selection manager 1150 is capable of, configured to, or operable to support a means for selecting, for each phase coherence group of the one or more phase coherence groups, a respective port of the second set of multiple ports having a lowest port index.

In some examples, the phase coherence group manager 1145 is capable of, configured to, or operable to support a means for identifying one or more phase coherence groups based on the phase coherence between the first port and the second port, where: each phase coherence group of the one or more phase coherence groups includes one or more CDM groups, each CDM group of the one or more CDM groups includes a first set of multiple ports associated with the communication of the DMRSs, and the first set of multiple ports correspond to a second set of multiple ports associated with the communication of the phase continuity reference signals. In some examples, the port selection manager 1150 is capable of, configured to, or operable to support a means for selecting, for each CDM group of the one or more CDM groups of each phase coherence group, a respective port of the second set of multiple ports having a lowest port index of the second set of multiple ports.

In some examples, to support, based on one or more ports associated with the communication of the DMRSs in a CDM group being non-coherent or partial coherent, the configuration, the phase continuity reference signal manager 1135 is capable of, configured to, or operable to support a means for transmitting a first phase continuity reference signal via a first resource element associated with the third port. In some examples, to support, based on one or more ports associated with the communication of the DMRSs in a CDM group being non-coherent or partial coherent, the configuration, the phase continuity reference signal manager 1135 is capable of, configured to, or operable to support a means for transmitting a second phase continuity reference signal via a second resource element associated with the fourth port.

In some examples, the one or more ports associated with the communication of the DMRSs include active DMRS ports.

In some examples, to support, based on one or more ports associated with the communication of the DMRSs in a CDM group being coherent, the configuration, the phase continuity reference signal manager 1135 is capable of, configured to, or operable to support a means for transmitting a first phase continuity reference signal via a first resource element associated with the third port and the fourth port or associated with the third port.

In some examples, the one or more ports associated with the communication of the DMRSs include active DMRS ports.

In some examples, the configuration for the phase continuity reference signals is associated with a CDM group.

In some examples, the control message manager 1155 is capable of, configured to, or operable to support a means for communicating a control message indicative of the configuration for the phase continuity reference signals based on the phase coherence between the first port and the second port, where transmitting the one or more phase continuity reference signals is based on the control message.

In some examples, the control message includes a mapping of the one or more first ports associated with the communication of the DMRSs to the one or more second ports associated with the communication of the phase continuity reference signals. In some examples, the one or more first ports include active DMRS ports.

In some examples, the capability manager 1160 is capable of, configured to, or operable to support a means for transmitting an UCI message indicative of a capability of a UE to adjust the phase coherence.

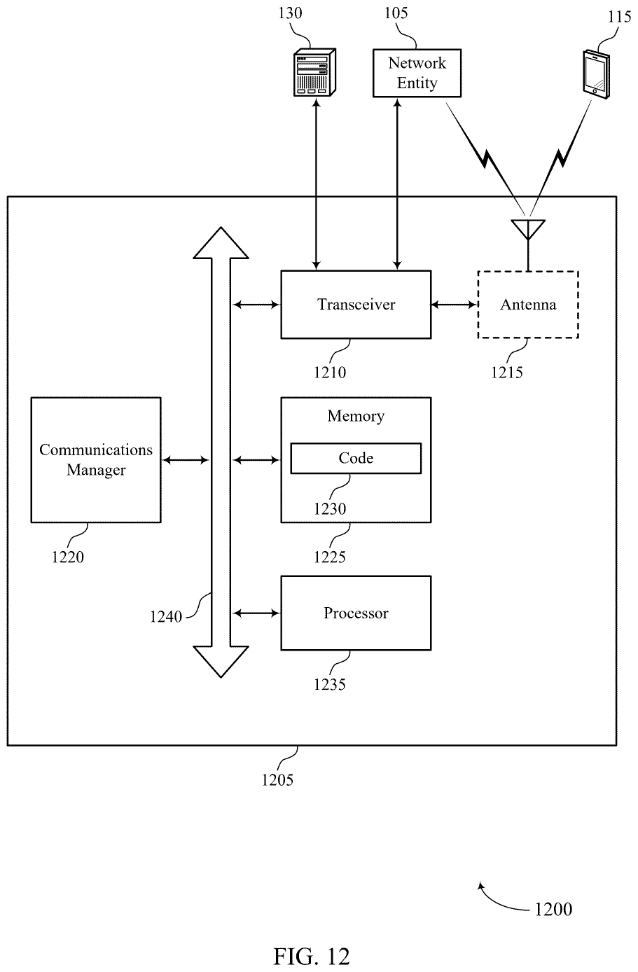

FIG. 12 shows a diagram of a system 1200 including a device 1205 that supports multi-port phase continuity reference signals in accordance with one or more aspects of the present disclosure. The device 1205 may be an example of or include components of a device 905, a device 1005, or a transmitting device as described herein. The device 1205 may include components for bi-directional voice and data communications including components for transmitting and receiving communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting multi-port phase continuity reference signals). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for determining a phase coherence between a first port and a second port. The communications manager 1220 is capable of, configured to, or operable to support a means for selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The communications manager 1220 is capable of, configured to, or operable to support a means for transmitting one or more phase continuity reference signals in accordance with the configuration, the one or more phase continuity reference signals associated with estimation of a phase discontinuity between the first port and the second port.

By including or configuring the communications manager 1220 in accordance with examples as described herein, the device 1205 may support techniques for more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of multi-port phase continuity reference signals as described herein, or the at least one processor 1235 and the at least one memory 1225 may be otherwise configured to, individually or collectively, perform or support such operations.

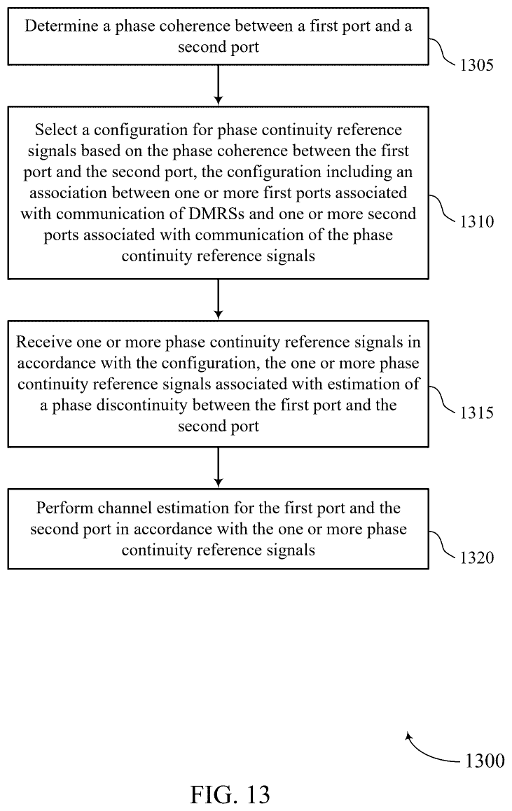

FIG. 13 shows a flowchart illustrating a method 1300 that supports multi-port phase continuity reference signals in accordance with one or more aspects of the present disclosure. The operations of the method 1300 may be implemented by a receiving device or its components as described herein. For example, the operations of the method 1300 may be performed by a receiving device as described with reference to FIGS. 1 through 8. In some examples, a receiving device may execute a set of instructions to control the functional elements of the receiving device to perform the described functions. Additionally, or alternatively, the receiving device may perform aspects of the described functions using special-purpose hardware.

At 1305, the method may include determining a phase coherence between a first port and a second port. The operations of 1305 may be performed in accordance with examples as disclosed herein. In some examples, aspects of the operations of 1305 may be performed by a phase coherence component 725 as described with reference to FIG. 7.

At 1310, the method may include selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The operations of 1310 may be performed in accordance with examples as disclosed herein. In some examples, aspects of the operations of 1310 may be performed by a configuration selection component 730 as described with reference to FIG. 7.

At 1315, the method may include receiving one or more phase continuity reference signals in accordance with the configuration, the one or more phase continuity reference signals associated with estimation of a phase discontinuity between the first port and the second port. The operations of 1315 may be performed in accordance with examples as disclosed herein. In some examples, aspects of the operations of 1315 may be performed by a phase continuity reference signal component 735 as described with reference to FIG. 7.

At 1320, the method may include performing channel estimation for the first port and the second port in accordance with the one or more phase continuity reference signals. The operations of 1320 may be performed in accordance with examples as disclosed herein. In some examples, aspects of the operations of 1320 may be performed by a channel estimation component 740 as described with reference to FIG. 7.

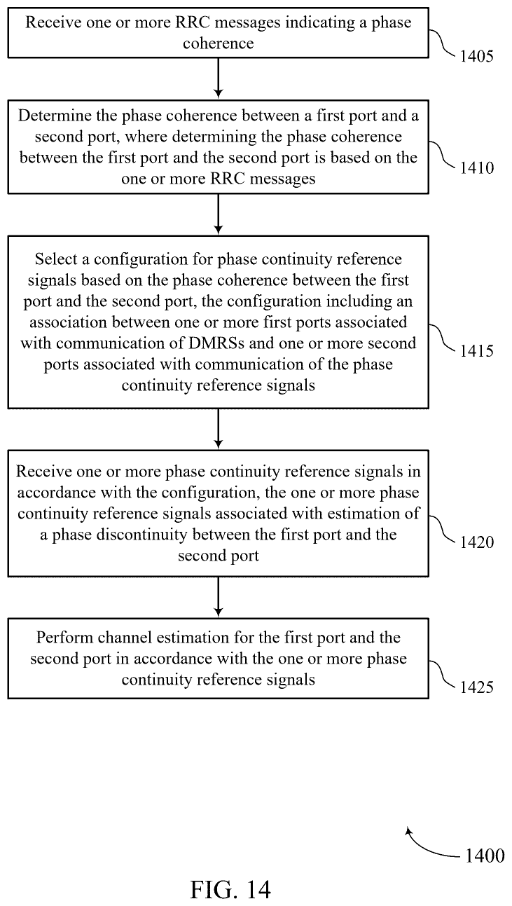

FIG. 14 shows a flowchart illustrating a method 1400 that supports multi-port phase continuity reference signals in accordance with one or more aspects of the present disclosure. The operations of the method 1400 may be implemented by a receiving device or its components as described herein. For example, the operations of the method 1400 may be performed by a receiving device as described with reference to FIGS. 1 through 8. In some examples, a receiving device may execute a set of instructions to control the functional elements of the receiving device to perform the described functions. Additionally, or alternatively, the receiving device may perform aspects of the described functions using special-purpose hardware.

At 1405, the method may include receiving one or more RRC messages indicating the phase coherence. The operations of 1405 may be performed in accordance with examples as disclosed herein. In some examples, aspects of the operations of 1405 may be performed by an RRC message component 745 as described with reference to FIG. 7.

At 1410, the method may include determining a phase coherence between a first port and a second port, where determining the phase coherence between the first port and the second port is based on the one or more RRC messages. The operations of 1410 may be performed in accordance with examples as disclosed herein. In some examples, aspects of the operations of 1410 may be performed by a phase coherence component 725 as described with reference to FIG. 7.

At 1415, the method may include selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The operations of 1415 may be performed in accordance with examples as disclosed herein. In some examples, aspects of the operations of 1415 may be performed by a configuration selection component 730 as described with reference to FIG. 7.

At 1420, the method may include receiving one or more phase continuity reference signals in accordance with the configuration, the one or more phase continuity reference signals associated with estimation of a phase discontinuity between the first port and the second port. The operations of 1420 may be performed in accordance with examples as disclosed herein. In some examples, aspects of the operations of 1420 may be performed by a phase continuity reference signal component 735 as described with reference to FIG. 7.

At 1425, the method may include performing channel estimation for the first port and the second port in accordance with the one or more phase continuity reference signals. The operations of 1425 may be performed in accordance with examples as disclosed herein. In some examples, aspects of the operations of 1425 may be performed by a channel estimation component 740 as described with reference to FIG. 7.

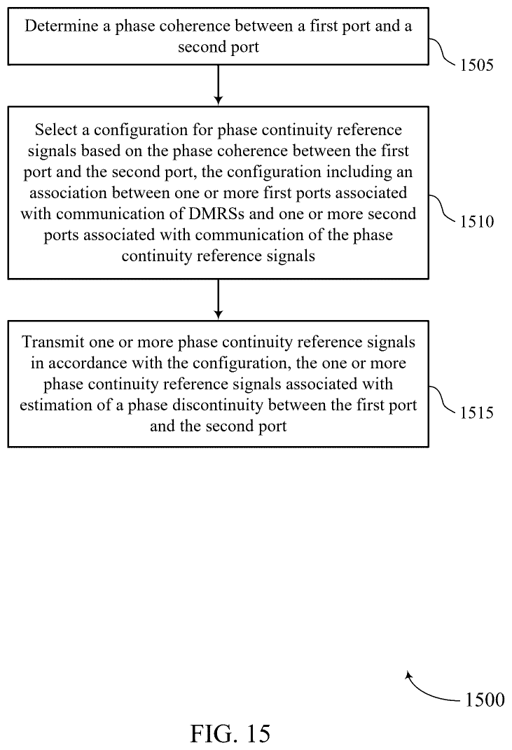

FIG. 15 shows a flowchart illustrating a method 1500 that supports multi-port phase continuity reference signals in accordance with one or more aspects of the present disclosure. The operations of the method 1500 may be implemented by a transmitting device or its components as described herein. For example, the operations of the method 1500 may be performed by a transmitting device as described with reference to FIGS. 1 through 4 and 9 through 12. In some examples, a transmitting device may execute a set of instructions to control the functional elements of the transmitting device to perform the described functions. Additionally, or alternatively, the transmitting device may perform aspects of the described functions using special-purpose hardware.

At 1505, the method may include determining a phase coherence between a first port and a second port. The operations of 1505 may be performed in accordance with examples as disclosed herein. In some examples, aspects of the operations of 1505 may be performed by a phase coherence manager 1125 as described with reference to FIG. 11.

At 1510, the method may include selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The operations of 1510 may be performed in accordance with examples as disclosed herein. In some examples, aspects of the operations of 1510 may be performed by a configuration selection manager 1130 as described with reference to FIG. 11.

At 1515, the method may include transmitting one or more phase continuity reference signals in accordance with the configuration, the one or more phase continuity reference signals associated with estimation of a phase discontinuity between the first port and the second port. The operations of 1515 may be performed in accordance with examples as disclosed herein. In some examples, aspects of the operations of 1515 may be performed by a phase continuity reference signal manager 1135 as described with reference to FIG. 11.

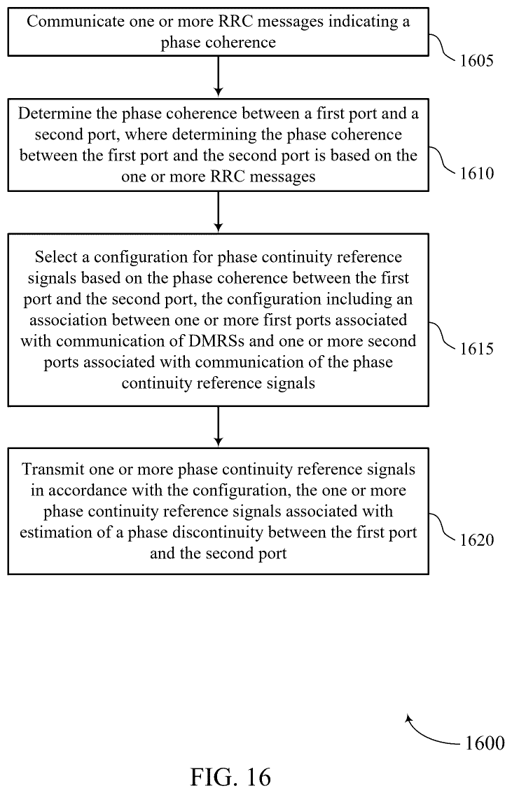

FIG. 16 shows a flowchart illustrating a method 1600 that supports multi-port phase continuity reference signals in accordance with one or more aspects of the present disclosure. The operations of the method 1600 may be implemented by a transmitting device or its components as described herein. For example, the operations of the method 1600 may be performed by a transmitting device as described with reference to FIGS. 1 through 4 and 9 through 12. In some examples, a transmitting device may execute a set of instructions to control the functional elements of the transmitting device to perform the described functions. Additionally, or alternatively, the transmitting device may perform aspects of the described functions using special-purpose hardware.

At 1605, the method may include communicating one or more RRC messages indicating a phase coherence. The operations of 1605 may be performed in accordance with examples as disclosed herein. In some examples, aspects of the operations of 1605 may be performed by an RRC message manager 1140 as described with reference to FIG. 11.

At 1610, the method may include determining a phase coherence between a first port and a second port, where determining the phase coherence between the first port and the second port is based on the one or more RRC messages. The operations of 1610 may be performed in accordance with examples as disclosed herein. In some examples, aspects of the operations of 1610 may be performed by a phase coherence manager 1125 as described with reference to FIG. 11.

At 1615, the method may include selecting a configuration for phase continuity reference signals based on the phase coherence between the first port and the second port, the configuration including an association between one or more first ports associated with communication of demodulation reference signals (DMRSs) and one or more second ports associated with communication of the phase continuity reference signals. The operations of 1615 may be performed in accordance with examples as disclosed herein. In some examples, aspects of the operations of 1615 may be performed by a configuration selection manager 1130 as described with reference to FIG. 11.

At 1620, the method may include transmitting one or more phase continuity reference signals in accordance with the configuration, the one or more phase continuity reference signals associated with estimation of a phase discontinuity between the first port and the second port. The operations of 1620 may be performed in accordance with examples as disclosed herein. In some examples, aspects of the operations of 1620 may be performed by a phase continuity reference signal manager 1135 as described with reference to FIG. 11.

The following provides an overview of aspects of the present disclosure:

Aspect 1: A method for wireless communications by a wireless communications device, comprising: determining a phase coherence between a first port and a second port; selecting a configuration for phase continuity reference signals based at least in part on the phase coherence between the first port and the second port, the configuration comprising an association between one or more first ports associated with communication of DMRSs and one or more second ports associated with communication of the phase continuity reference signals; receiving one or more phase continuity reference signals in accordance with the configuration, the one or more phase continuity reference signals associated with estimation of a phase discontinuity between the first port and the second port; and performing channel estimation for the first port and the second port in accordance with the one or more phase continuity reference signals.

Aspect 2: The method of aspect 1, further comprising: receiving one or more RRC messages indicating the phase coherence, wherein determining the phase coherence between the first port and the second port is based at least in part on the one or more RRC messages.

Aspect 3: The method of aspect 2, wherein the one or more RRC messages comprise a capability report, an indication of one or more coherent ports, or both.

Aspect 4: The method of any of aspects 1 through 3, wherein the one or more phase continuity reference signals are received via the one or more second ports comprising the second port in accordance with the configuration, the one or more second ports associated with the one or more first ports that comprise one or more active DMRS ports.

Aspect 5: The method of any of aspects 1 through 4, further comprising: identifying one or more phase coherence groups based at least in part on the phase coherence between the first port and the second port, wherein: each phase coherence group of the one or more phase coherence groups comprises a first plurality of ports associated with the communication of the DMRSs, and the first plurality of ports correspond to a second plurality of ports associated with the communication of the phase continuity reference signals; and selecting, for each phase coherence group of the one or more phase coherence groups, a respective port of the second plurality of ports having a lowest port index.

Aspect 6: The method of any of aspects 1 through 5, further comprising: identifying one or more phase coherence groups based at least in part on the phase coherence between the first port and the second port, wherein: each phase coherence group of the one or more phase coherence groups comprises one or more CDM groups, each CDM group of the one or more CDM groups comprises a first plurality of ports associated with the communication of the DMRSs, and the first plurality of ports correspond to a second plurality of ports associated with the communication of the phase continuity reference signals; and selecting, for each CDM group of the one or more CDM groups of each phase coherence group, a respective port of the second plurality of ports having a lowest port index of the second plurality of ports.

Aspect 7: The method of any of aspects 1 through 6, wherein, based at least in part on one or more ports associated with the communication of the DMRSs in a CDM group being non-coherent or partial coherent, the configuration comprises: a third port and a fourth port associated with the communication of the phase continuity reference signals, the third port and the fourth port being associated with a fifth port and a sixth port of the one or more ports, and wherein receiving the one or more phase continuity reference signals comprises: receiving a first phase continuity reference signal via a first resource element associated with the third port; and receiving a second phase continuity reference signal via a second resource element associated with the fourth port.

Aspect 8: The method of aspect 7, wherein the one or more ports associated with the communication of the DMRSs comprise active DMRS ports.

Aspect 9: The method of any of aspects 1 through 8, wherein, based at least in part on one or more ports associated with the communication of the DMRSs in a CDM group being coherent, the configuration comprises: a third port and a fourth port associated with the communication of the phase continuity reference signals, the third port and the fourth port being associated with a fifth port and a sixth port of the one or more ports, or the third port associated with the communication of the phase continuity reference signals, the third port having the association with the fifth port and the sixth port, and wherein receiving the one or more phase continuity reference signals comprises: receiving a first phase continuity reference signal via a first resource element associated with the third port and the fourth port or associated with the third port.

Aspect 10: The method of aspect 9, wherein the one or more ports associated with the communication of the DMRSs comprise active DMRS ports.

Aspect 11: The method of any of aspects 1 through 10, wherein the configuration for the phase continuity reference signals is associated with a CDM group.

Aspect 12: The method of any of aspects 1 through 11, further comprising: communicating a control message indicative of the configuration for the phase continuity reference signals based at least in part on the phase coherence between the first port and the second port, wherein receiving the one or more phase continuity reference signals is based at least in part on the control message.

Aspect 13: The method of aspect 12, wherein the control message comprises a mapping of the one or more first ports associated with the communication of the DMRSs to the one or more second ports associated with the communication of the phase continuity reference signals, and the one or more first ports comprise active DMRS ports.

Aspect 14: The method of any of aspects 1 through 13, further comprising: receiving an UCI message indicative of a capability of a UE to adjust the phase coherence.

Aspect 15: A method for wireless communications by a wireless communications device, comprising: determining a phase coherence between a first port and a second port; selecting a configuration for phase continuity reference signals based at least in part on the phase coherence between the first port and the second port, the configuration comprising an association between one or more first ports associated with communication of DMRS and one or more second ports associated with communication of the phase continuity reference signals; and transmitting one or more phase continuity reference signals in accordance with the configuration, the one or more phase continuity reference signals associated with estimation of a phase discontinuity between the first port and the second port.

Aspect 16: The method of aspect 15, further comprising: communicating one or more RRC messages indicating the phase coherence, wherein determining the phase coherence between the first port and the second port is based at least in part on the one or more RRC messages.

Aspect 17: The method of aspect 16, wherein the one or more RRC messages comprise a capability report, an indication of one or more coherent ports, or both.

Aspect 18: The method of any of aspects 15 through 17, wherein the one or more phase continuity reference signals are transmitted via the one or more second ports comprising the first port in accordance with the configuration, the one or more second ports associated with the one or more first ports that comprise one or more active DMRS ports.

Aspect 19: The method of any of aspects 15 through 18, further comprising: identifying one or more phase coherence groups based at least in part on the phase coherence between the first port and the second port, wherein: each phase coherence group of the one or more phase coherence groups comprises a first plurality of ports associated with the communication of the DMRSs, and the first plurality of ports correspond to a second plurality of ports associated with the communication of the phase continuity reference signals; and selecting, for each phase coherence group of the one or more phase coherence groups, a respective port of the second plurality of ports having a lowest port index.

Aspect 20: The method of any of aspects 15 through 19, further comprising: identifying one or more phase coherence groups based at least in part on the phase coherence between the first port and the second port, wherein: each phase coherence group of the one or more phase coherence groups comprises one or more CDM groups, each CDM group of the one or more CDM groups comprises a first plurality of ports associated with the communication of the DMRSs, and the first plurality of ports correspond to a second plurality of ports associated with the communication of the phase continuity reference signals; and selecting, for each CDM group of the one or more CDM groups of each phase coherence group, a respective port of the second plurality of ports having a lowest port index of the second plurality of ports.

Aspect 21: The method of any of aspects 15 through 20, wherein, based at least in part on one or more ports associated with the communication of the DMRSs in a CDM group being non-coherent or partial coherent, the configuration comprises: a third port and a fourth port associated with the communication of the phase continuity reference signals, the third port and the fourth port being associated with a fifth port and a sixth port of the one or more ports, and wherein transmitting the one or more phase continuity reference signals comprises: transmitting a first phase continuity reference signal via a first resource element associated with the third port; and transmitting a second phase continuity reference signal via a second resource element associated with the fourth port.

Aspect 22: The method of aspect 21, wherein the one or more ports associated with the communication of the DMRSs comprise active DMRS ports.

Aspect 23: The method of any of aspects 15 through 22, wherein, based at least in part on one or more ports associated with the communication of the DMRSs in a CDM group being coherent, the configuration comprises: a third port and a fourth port associated with the communication of the phase continuity reference signals, the third port and the fourth port being associated with a fifth port and a sixth port of the one or more ports, or the third port associated with the communication of the phase continuity reference signals, the third port having the association with the fifth port and the sixth port, and wherein transmitting the one or more phase continuity reference signals comprises: transmitting a first phase continuity reference signal via a first resource element associated with the third port and the fourth port or associated with the third port.

Aspect 24: The method of aspect 23, wherein the one or more ports associated with the communication of the DMRSs comprise active DMRS ports.

Aspect 25: The method of any of aspects 15 through 24, wherein the configuration for the phase continuity reference signals is associated with a CDM group.

Aspect 26: The method of any of aspects 15 through 25, further comprising: communicating a control message indicative of the configuration for the phase continuity reference signals based at least in part on the phase coherence between the first port and the second port, wherein transmitting the one or more phase continuity reference signals is based at least in part on the control message.

Aspect 27: The method of aspect 26, wherein the control message comprises a mapping of the one or more first ports associated with the communication of the DMRSs to the one or more second ports associated with the communication of the phase continuity reference signals, and the one or more first ports comprise active DMRS ports.

Aspect 28: The method of any of aspects 15 through 27, further comprising: transmitting an UCI message indicative of a capability of a UE to adjust the phase coherence.

Aspect 29: A wireless communications device for wireless communications, comprising one or more memories storing processor-executable code, and one or more processors coupled with the one or more memories and individually or collectively operable to execute the code to cause the wireless communications device to perform a method of any of aspects 1 through 14.

Aspect 30: A wireless communications device for wireless communications, comprising at least one means for performing a method of any of aspects 1 through 14.

Aspect 31: A non-transitory computer-readable medium storing code for wireless communications, the code comprising instructions executable by one or more processors to perform a method of any of aspects 1 through 14.

Aspect 32: A wireless communications device for wireless communications, comprising one or more memories storing processor-executable code, and one or more processors coupled with the one or more memories and individually or collectively operable to execute the code to cause the wireless communications device to perform a method of any of aspects 15 through 28.

Aspect 33: A wireless communications device for wireless communications, comprising at least one means for performing a method of any of aspects 15 through 28.

Aspect 34: A non-transitory computer-readable medium storing code for wireless communications, the code comprising instructions executable by one or more processors to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless communications device, comprising:
one or more memories storing processor-executable code; and
one or more processors coupled with the one or more memories and individually or collectively operable to execute the code to cause the wireless communications device to:
determine a phase coherence between a first port and a second port;
select a configuration for phase continuity reference signals based at least in part on the phase coherence between the first port and the second port, the configuration comprising an association between one or more first ports associated with communication of demodulation reference signals (DMRSs) and one or more second ports associated with communication of the phase continuity reference signals;
receive one or more phase continuity reference signals in accordance with the configuration, the one or more phase continuity reference signals associated with estimation of a phase discontinuity between the first port and the second port; and
perform channel estimation for the first port and the second port in accordance with the one or more phase continuity reference signals.

2. The wireless communications device of claim 1, wherein the one or more processors are individually or collectively further operable to execute the code to cause the wireless communications device to:
receive one or more radio resource control (RRC) messages indicating the phase coherence, wherein determining the phase coherence between the first port and the second port is based at least in part on the one or more RRC messages.

3. The wireless communications device of claim 2, wherein the one or more RRC messages comprise a capability report, an indication of one or more coherent ports, or both.

4. The wireless communications device of claim 1, wherein the one or more phase continuity reference signals are received via the one or more second ports comprising the second port in accordance with the configuration, the one or more second ports associated with the one or more first ports that comprise one or more active DMRS ports.

5. The wireless communications device of claim 1, wherein the one or more processors are individually or collectively further operable to execute the code to cause the wireless communications device to:
identify one or more phase coherence groups based at least in part on the phase coherence between the first port and the second port, wherein: each phase coherence group of the one or more phase coherence groups comprises a first plurality of ports associated with the communication of the DMRSs, and the first plurality of ports correspond to a second plurality of ports associated with the communication of the phase continuity reference signals; and
select, for each phase coherence group of the one or more phase coherence groups, a respective port of the second plurality of ports having a lowest port index.

6. The wireless communications device of claim 1, wherein the one or more processors are individually or collectively further operable to execute the code to cause the wireless communications device to:
identify one or more phase coherence groups based at least in part on the phase coherence between the first port and the second port, wherein: each phase coherence group of the one or more phase coherence groups comprises one or more code division multiplexing (CDM) groups, each CDM group of the one or more CDM groups comprises a first plurality of ports associated with the communication of the DMRSs, and the first plurality of ports correspond to a second plurality of ports associated with the communication of the phase continuity reference signals; and
select, for each CDM group of the one or more CDM groups of each phase coherence group, a respective port of the second plurality of ports having a lowest port index of the second plurality of ports.

7. The wireless communications device of claim 1, wherein, based at least in part on one or more ports associated with the communication of the DMRSs in a code division multiplexing (CDM) group being non-coherent or partial coherent, the configuration comprises:
a third port and a fourth port associated with the communication of the phase continuity reference signals, the third port and the fourth port being associated with a fifth port and a sixth port of the one or more ports, and wherein, to receive the one or more phase continuity reference signals, the one or more processors are individually or collectively operable to execute the code to cause the wireless communications device to:
receive a first phase continuity reference signal via a first resource element associated with the third port; and
receive a second phase continuity reference signal via a second resource element associated with the fourth port.

8. The wireless communications device of claim 7, wherein the one or more ports associated with the communication of the DMRSs comprise active DMRS ports.

9. The wireless communications device of claim 1, wherein, based at least in part on one or more ports associated with the communication of the DMRSs in a code division multiplexing (CDM) group being coherent, the configuration comprises:
a third port and a fourth port associated with the communication of the phase continuity reference signals, the third port and the fourth port being associated with a fifth port and a sixth port of the one or more ports, or the third port associated with the communication of the phase continuity reference signals, the third port having the association with the fifth port and the sixth port, and wherein, to receive the one or more phase continuity reference signals, the one or more processors are individually or collectively operable to execute the code to cause the wireless communications device to:
receive a first phase continuity reference signal via a first resource element associated with the third port and the fourth port or associated with the third port.

10. The wireless communications device of claim 9, wherein the one or more ports associated with the communication of the DMRSs comprise active DMRS ports.

11. The wireless communications device of claim 1, wherein the configuration for the phase continuity reference signals is associated with a code division multiplexing (CDM) group.

12. The wireless communications device of claim 1, wherein the one or more processors are individually or collectively further operable to execute the code to cause the wireless communications device to:
communicate a control message indicative of the configuration for the phase continuity reference signals based at least in part on the phase coherence between the first port and the second port, wherein receiving the one or more phase continuity reference signals is based at least in part on the control message.

13. The wireless communications device of claim 12, wherein:
the control message comprises a mapping of the one or more first ports associated with the communication of the DMRSs to the one or more second ports associated with the communication of the phase continuity reference signals, and
the one or more first ports comprise active DMRS ports.

14. The wireless communications device of claim 1, wherein the one or more processors are individually or collectively further operable to execute the code to cause the wireless communications device to:
receive an uplink control information (UCI) message indicative of a capability of a user equipment (UE) to adjust the phase coherence.

15. A wireless communications device, comprising:
one or more memories storing processor-executable code; and
one or more processors coupled with the one or more memories and individually or collectively operable to execute the code to cause the wireless communications device to:
determine a phase coherence between a first port and a second port;
select a configuration for phase continuity reference signals based at least in part on the phase coherence between the first port and the second port, the configuration comprising an association between one or more first ports associated with communication of demodulation reference signals (DMRSs) and one or more second ports associated with communication of the phase continuity reference signals; and
transmit one or more phase continuity reference signals in accordance with the configuration, the one or more phase continuity reference signals associated with estimation of a phase discontinuity between the first port and the second port.

16. The wireless communications device of claim 15, wherein the one or more processors are individually or collectively further operable to execute the code to cause the wireless communications device to:
communicate one or more radio resource control (RRC) messages indicating the phase coherence, wherein determining the phase coherence between the first port and the second port is based at least in part on the one or more RRC messages.

17. The wireless communications device of claim 16, wherein the one or more RRC messages comprise a capability report, an indication of one or more coherent ports, or both.

18. The wireless communications device of claim 15, wherein the one or more phase continuity reference signals are transmitted via the one or more second ports comprising the first port in accordance with the configuration, the one or more second ports associated with the one or more first ports that comprise one or more active DMRS ports.

19. The wireless communications device of claim 15, wherein the one or more processors are individually or collectively further operable to execute the code to cause the wireless communications device to:
identify one or more phase coherence groups based at least in part on the phase coherence between the first port and the second port, wherein: each phase coherence group of the one or more phase coherence groups comprises a first plurality of ports associated with the communication of the DMRSs, and the first plurality of ports correspond to a second plurality of ports associated with the communication of the phase continuity reference signals; and
select, for each phase coherence group of the one or more phase coherence groups, a respective port of the second plurality of ports having a lowest port index.

20. The wireless communications device of claim 15, wherein the one or more processors are individually or collectively further operable to execute the code to cause the wireless communications device to:
identify one or more phase coherence groups based at least in part on the phase coherence between the first port and the second port, wherein: each phase coherence group of the one or more phase coherence groups comprises one or more code division multiplexing (CDM) groups, each CDM group of the one or more CDM groups comprises a first plurality of ports associated with the communication of the DMRSs, and the first plurality of ports correspond to a second plurality of ports associated with the communication of the phase continuity reference signals; and
select, for each CDM group of the one or more CDM groups of each phase coherence group, a respective port of the second plurality of ports having a lowest port index of the second plurality of ports.

21. The wireless communications device of claim 15, wherein, based at least in part on one or more ports associated with the communication of the DMRSs in a code division multiplexing (CDM) group being non-coherent or partial coherent, the configuration comprises:
a third port and a fourth port associated with the communication of the phase continuity reference signals, the third port and the fourth port being associated with a fifth port and a sixth port of the one or more ports, and wherein, to transmit the one or more phase continuity reference signals, the one or more processors are individually or collectively operable to execute the code to cause the wireless communications device to:
transmit a first phase continuity reference signal via a first resource element associated with the third port; and
transmit a second phase continuity reference signal via a second resource element associated with the fourth port.

22. The wireless communications device of claim 21, wherein the one or more ports associated with the communication of the DMRSs comprise active DMRS ports.

23. The wireless communications device of claim 15, wherein, based at least in part on one or more ports associated with the communication of the DMRSs in a code division multiplexing (CDM) group being coherent, the configuration comprises:
a third port and a fourth port associated with the communication of the phase continuity reference signals, the third port and the fourth port being associated with a fifth port and a sixth port of the one or more ports, or the third port associated with the communication of the phase continuity reference signals, the third port having the association with the fifth port and the sixth port, and wherein, to transmit the one or more phase continuity reference signals, the one or more processors are individually or collectively operable to execute the code to cause the wireless communications device to:
transmit a first phase continuity reference signal via a first resource element associated with the third port and the fourth port or associated with the third port.

24. The wireless communications device of claim 23, wherein the one or more ports associated with the communication of the DMRSs comprise active DMRS ports.

25. The wireless communications device of claim 15, wherein the configuration for the phase continuity reference signals is associated with a code division multiplexing (CDM) group.

26. The wireless communications device of claim 15, wherein the one or more processors are individually or collectively further operable to execute the code to cause the wireless communications device to:
communicate a control message indicative of the configuration for the phase continuity reference signals based at least in part on the phase coherence between the first port and the second port, wherein transmitting the one or more phase continuity reference signals is based at least in part on the control message.

27. The wireless communications device of claim 26, wherein:
the control message comprises a mapping of the one or more first ports associated with the communication of the DMRSs to the one or more second ports associated with the communication of the phase continuity reference signals, and
the one or more first ports comprise active DMRS ports.

28. The wireless communications device of claim 15, wherein the one or more processors are individually or collectively further operable to execute the code to cause the wireless communications device to:
transmit an uplink control information (UCI) message indicative of a capability of a user equipment (UE) to adjust the phase coherence.

29. A method for wireless communications by a wireless communications device, comprising:
determining a phase coherence between a first port and a second port;
selecting a configuration for phase continuity reference signals based at least in part on the phase coherence between the first port and the second port, the configuration comprising an association between one or more first ports associated with communication of demodulation reference signals (DMRSs) and one or more second ports associated with communication of the phase continuity reference signals;
receiving one or more phase continuity reference signals in accordance with the configuration, the one or more phase continuity reference signals associated with estimation of a phase discontinuity between the first port and the second port; and
performing channel estimation for the first port and the second port in accordance with the one or more phase continuity reference signals.

30. A method for wireless communications by a wireless communications device, comprising:
determining a phase coherence between a first port and a second port;
selecting a configuration for phase continuity reference signals based at least in part on the phase coherence between the first port and the second port, the configuration comprising an association between one or more first ports associated with communication of demodulation reference signals (DMRSs) and one or more second ports associated with communication of the phase continuity reference signals; and
transmitting one or more phase continuity reference signals in accordance with the configuration, the one or more phase continuity reference signals associated with estimation of a phase discontinuity between the first port and the second port.
